(19) United States
(12) Patent Application Publication
(10) Pub. No.: US 2026/0098585 A1
(43) Pub. Date: Apr. 9, 2026

(54) FLOW PATH SWITCHING DEVICE

(71) Applicant: AISAN KOGYO KABUSHIKI KAISHA, Obu-shi, Aichi (JP)

(72) Inventors: Mamoru YOSHIOKA, Susono-shi (JP); Shinji KAWAI, Gifu-shi (JP); Kazumasa NAKASHIMA, Nagoya-shi (JP); Shogo IWADE, Nagoya-shi (JP); Masanao KURITA, Toyoake-shi (JP)

(73) Assignee: AISAN KOGYO KABUSHIKI KAISHA, Obu-shi, Aichi-ken (JP)

(21) Appl. No.: 19/111,014

(22) PCT Filed: Oct. 3, 2023
(86) PCT No.: PCT/JP2023/036080

§ 371 Date: Mar. 12, 2025

(30) Foreign Application Priority Data
Oct. 17, 2022 (JP) 2022-166109
May 10, 2023 (JP) 2023-077987

(51) Int. Cl. F16K 11/074; F16K 25/00

(52) U.S. Cl. CPC F16K 11/074; F16K 25/00

(57) ABSTRACT

This flow path switching device has at least one fixed member and a driving member, wherein: the at least one fixed member includes a port; the driving member includes a communication path; and a flow path, through which a fluid flows, is formed by making the port of the at least one fixed member and the communication path of the driving member communicate with each other. The flow path switching device has a seal member which is provided to the driving member, comes into contact with the at least one fixed member under action of a pressing force, and thereby seals a gap between the port of the at least one fixed member and the communication path of the driving member communicating with the port of the at least one fixed member, and the driving member has rigidity higher than the at least one fixed member.

### TECHNICAL FIELD

The disclosure relates to a flow path switching device for switching between flow path patterns through which fluid flows.

### BACKGROUND ART

Patent Document 1 discloses a flow path switching valve in which a rotor seal provided on a rotor slides against a stator when the rotor rotates.

### RELATED ART DOCUMENTS

### Patent Documents

Patent Document 1: Japanese unexamined patent application publication No. 2020-144027

### SUMMARY OF INVENTION

### Problems to be Solved by the Invention

In the flow path switching device disclosed in Patent Document 1, while the rotor seal is traversing, or passing across, a stator flow path, the rotor seal will have a non-contact portion that is released into the stator flow path and does not contact with the stator and a contact portion that contacts with the stator. Therefore, local stress may occur in the boundary between the non-contact portion and the contact portion of the rotor seal. Thus, the rotor seal may wear and crack, and the sealing performance of the rotor seal may deteriorate.

The present disclosure has been made to address the above problems and has a purpose to provide a flow path switching device capable of securing the sealing performance of a seal member.

### Means of Solving the Problems

To achieve the above-mentioned purpose, one aspect of the present disclosure provides a flow path switching device comprising: at least one fixed member; and a driving member, the fixed member including a port, the driving member including a communication path, and the port of the fixed member is communicated with the communication path of the driving member to form a flow path through which fluid flows, wherein the driving member is provided with a seal member that contacts with the fixed member under action of a pressing force and seals a gap between the port of the fixed member and the communication path of the driving member communicated with the fixed member, and the driving member has a higher rigidity than the at least one fixed member.

According to this configuration, the driving member is highly rigid and less deformable, and thus the posture of the seal member provided in the driving member can be maintained. This configuration can prevent local stress from occurring in the seal member, and reduce wear and cracking of the seal member. Thus, the sealing performance of the seal member can be ensured.

In the above-described configuration, preferably, the fixed member includes a first fixed member and a second fixed member, the driving member is placed between the first fixed member and the second fixed member, the seal member includes a first seal member provided between the first fixed member and the driving member and a second seal member provided between the driving member and the second fixed member, the driving member is held between the first fixed member and the second fixed member under action of the pressing force through the second fixed member and the second seal member, and the port of the second fixed member is placed in a position where the port does not traverse the second seal member when the driving member is driven to switch patterns of the flow path.

According to this configuration, when the flow path patterns are switched by driving the driving member, the second seal member does not pass across the port of the second fixed member. This configuration can prevent deformation of the second fixed member. Thus, the second fixed member can be designed with a reduced thickness (with low rigidity). Furthermore, this can prevent the occurrence of local stress in the second seal member due to deformation of the second fixed member, the second seal member can be prevented from wearing and cracking. Thus, the sealing performance of the second seal member can be ensured.

In the above-described configuration, preferably, the port of the fixed member includes an opening edge on a side facing the driving member, the opening edge being formed with R or a taper, and a size of the R or taper is larger at a first end portion, which is an end portion of the opening edge in a driving direction of the driving member, than at a second end portion, which is an end portion of the opening edge in a direction perpendicular to the driving direction of the driving member, and the size of the R or taper gradually decreases from the first end portion toward the second end portion.

According to this configuration, when the flow path patterns are switched by driving the driving member, while the seal member traverses the port of the fixed member, the non-contact portion of the seal member, released into the port of the fixed member and does not contact with the fixed member, is less likely to get caught on the edge of the port of the fixed member when moving out of the port and coming into contact with the fixed member. Therefore, the seal member can be prevented from wearing and cracking. Thus, the sealing performance of the seal member can be ensured.

In the above-described configuration, preferably, when the driving member is driven to switch patterns of the flow path, a driving speed of the driving member is set to a first low speed that is slower than a normal speed while the seal member is traversing the port of the fixed member.

According to this configuration, an area where local stress occurs in the seal member can be gradually shifted as the seal member passes across the port of the fixed member. Therefore, the seal member can be prevented from wearing and cracking. Thus, the sealing performance of the seal member can be ensured.

In the above-described configuration, preferably, when the driving member is driven to switch the patterns of the flow path, the driving speed of the driving member is set to a second low speed that is slower than the first low speed while the seal member is shifting from a state of traversing the port of the fixed member to a state of not traversing the port.

According to this configuration, when the seal member shifts from the state of traversing the port of the fixed member to the state of not traversing the port, that is, when the non-contact portion of the seal member, released into the port of the fixed member and out of contact with the fixed member, moves from inside to outside of the port of the fixed member and rides on the contact surface with the fixed member, an area where local stress occurs in the seal member is gradually shifted. This configuration can therefore more effectively prevent the seal member from wearing and cracking. Thus, the sealing performance more effectively can be ensured.

In the above-described configuration, preferably, the port of the fixed member includes an opening edge on a side facing the driving member, the opening edge being formed with R or a taper, a size of the R or taper is larger at a first end portion which is an end portion of the opening edge in a driving direction of the driving member than at a second end portion which is an end portion of the opening edge in a direction perpendicular to the driving direction of the driving member, and a radius of an inner periphery of the opening edge and a radius of an outer periphery of the opening edge at the first end portion are equal or approximately equal to those at the second end portion.

According to this configuration, at the opening edge of the port of the fixed member on the side facing the driving member, the size of the R or the size of the taper is made larger at the first end portion than at the second end portion, while the radius of the inner periphery and the radius of the outer periphery of the opening edge are equal (or approximately equal) at the first and second end portions.

Accordingly, while the driving member is relatively driven with respect to the fixed member, when the seal member traverses the port of the fixed member, the seal member can be pushed up effectively to allow the portion of the seal member, once released into the port of the fixed member, to ride on the first end portion of the opening edge. This configuration allows the seal member to smoothly ride on the first end portion of the opening edge. Therefore, the seal member can smoothly pass through the port of the fixed member.

In the above-described configuration, preferably, when it is assumed that the radius of the inner periphery of the opening edge is r1 and the radius of the outer periphery of the opening edge is r2, the size of the R at the first end portion is larger than (r2−r1).

According to this configuration, the size of the R is reliably large at the first end portion of the opening edge. This configuration more reliably enables to effectively push up the seal member when the portion of the seal member, once released into the port of the fixed member, rides on the first end portion of the opening edge.

In the above-described configuration, preferably, the port of the fixed member includes an opening edge on a side facing the driving member, the opening edge being shaped such that a first opening curvature that is a curvature of a first end portion, which is an end portion of the opening edge in a driving direction of the driving member, is smaller than a second opening curvature that is a curvature of a second end portion, which is an end portion of the opening edge in a direction perpendicular to the driving direction of the driving member.

According to this configuration, the opening edge is shaped such that the curvature at the first end portion (namely, a first opening curvature) is set small.

Accordingly, while the seal member is traversing the port of the fixed member by driving the driving member with respect to the fixed member, the compression stress acting on the seal member is reduced just before the portion of the seal member, once released into the port of the fixed member, rides on the first end portion of the opening edge. Thus, the protruding amount of the seal member into the port of the fixed member is reduced. This allows the seal member to smoothly ride on the first end portion of the opening edge.

In the above-described configuration, preferably, the port of the fixed member has an opening edge on a side facing the driving member, the opening edge is shaped such that a first end portion, which is an end portion of the opening edge in a driving direction of the driving member, is formed with an edge straight portion having a straight-linear shape intersecting the driving direction.

According to this configuration, the opening edge is shaped such that the first end portion has a straight-linear shape intersecting the driving direction of the driving member.

Accordingly, while the seal member is traversing the port of the fixed member by driving the driving member relative to the fixed member, the compression stress acting on the seal member is reduced just before the portion of the seal member, once released into the port of the fixed member, rides on the first end portion of the opening edge. Thus, the protruding amount of the seal member into the port of the fixed member is reduced. This allows the seal member to smoothly ride on the first end portion of the opening edge.

In the above-described configuration, preferably, the seal member is shaped such that an end portion in a driving direction of the driving member is formed with a seal-member straight portion having a straight-linear shape or a seal-member nearly-straight portion having a nearly straight-linear shape intersecting the driving direction.

According to this configuration, the seal member is shaped such that the end portion in the driving direction of the driving member, that is, the portion of the seal member, which is once released into the port of the fixed member and rides on the first end portion of the opening edge when the seal member passes across the port of the fixed member by driving the driving member relative to the fixed member, is formed in a straight-linear or nearly straight-linear shape intersecting the driving direction of the driving member.

This configuration reduces the compression stress acting on the seal member just before the portion of the seal member, once released into the port of the fixed member, rides on the first end portion of the opening edge. Thus, the protruding amount of the seal member into the port of the fixed member is reduced. This allows the seal member to smoothly ride on the first end portion of the opening edge.

### Effects of the Invention

According to a flow path switching device of the disclosure, the sealing performance of the seal member can be ensured.

### BRIEF DESCRIPTION OF THE DRAWINGS

FIG. 1 is an external perspective view of a flow path switching device (a six-way valve) in first and second embodiments;

FIG. 2 is an exploded perspective view of the flow path switching device in the first and second embodiments, in which a drive unit and a control unit are omitted;

FIG. 3 is a cross-sectional view of the flow path switching device in the first and second embodiments, in which a drive unit and a control unit are omitted;

FIG. 4 is a top view of a rotary disk;

FIG. 5 is a top view of a fixed member;

FIG. 6 is an image diagram schematically showing a first flow path pattern when viewed from above the flow path switching device;

FIG. 7 is an image diagram schematically showing a second flow path pattern when viewed from above the flow path switching device;

FIG. 8 is a diagram showing a positional relationship between a first seal member and inflow paths when flow path patterns are switched;

FIG. 9 is an enlarged diagram of a third inflow path and its surroundings in FIG. 8(A);

FIG. 10 is a cross-sectional diagram of a housing, the rotary disk, and the fixed disk in FIG. 8(A);

FIG. 11 is an enlarged diagram of the third inflow path and its surroundings in FIG. 8(B);

FIG. 12 is a cross-sectional diagram of the housing, the rotary disk, and the fixed disk in FIG. 8(B);

FIG. 13 is a diagram showing a positional relationship between a second seal member and rotary-disk communication paths when flow path patterns are switched;

FIG. 14 is a cross-sectional diagram along A-A in FIG. 11;

FIG. 15 is a cross-sectional diagram along B-B in FIG. 11;

FIG. 16 is a flowchart showing contents of a first control related to rotation speed of a rotary member;

FIG. 17 is a diagram showing the movement locus of the first seal member when the control in FIG. 16 is performed;

FIG. 18 is a flowchart showing contents of a second control related to rotation speed of the rotary member;

FIG. 19 is a diagram showing the movement locus of the first seal member when the control in FIG. 18 is performed;

FIG. 20 is a schematic overall diagram of a sliding-type flow path switching device, showing a first flow path pattern;

FIG. 21 is a cross-sectional diagram along C-C in FIG. 20;

FIG. 22 is a schematic overall diagram of the sliding-type flow path switching device, showing a second flow path pattern;

FIG. 23 is a cross-sectional diagram along D-D in FIG. 22;

FIG. 24 is a diagram showing a situation where the second seal member is traversing a fixed-disk communication path;

FIG. 25 is a diagram showing a situation where the second seal member is traversing the fixed-disk communication path;

FIG. 26 is a diagram showing that the first seal member catches on an opening edge of an inflow path;

FIG. 27 is a diagram of a housing seen from a rotary disk side, showing an opening edge of an inflow path and a first seal member in a second embodiment;

FIG. 28 (A) is a diagram seen from arrows E-E in FIG. 27, (B) is a diagram seen from arrows F-F in FIG. 27, and (C) is a diagram showing the position of an inner periphery of the opening edge of the inflow path;

FIG. 29 is a diagram showing how a portion of the first seal member, once released into the inflow path, rides on a first end portion of the opening edge of the inflow path in the second embodiment;

FIG. 30 is a diagram showing a first variant example;

FIG. 31 is a diagram showing a second variant example;

FIG. 32 is a diagram showing another example of the second variant example;

FIG. 33 is a diagram showing a third variant example;

FIG. 34 is a diagram showing when the first seal member moves from a first end portion of an opening edge of the inflow path, located on an opposite side to a rotation direction of a rotary disk, toward a second end portion;

FIG. 35 is a diagram showing that tensile stress occurs in the first seal member at the time shown in FIG. 34;

FIG. 36 is a diagram showing when the first seal member moves from the second end portion of the opening edge of the inflow path to the first end portion located on the forward side in the rotation direction of the rotary disk;

FIG. 37 is a diagram showing that tensile stress occurs in the first seal member at the time shown in FIG. 36;

FIG. 38 is a diagram showing that a portion of the first seal member, once released into the inflow path, is pushed up from the inflow path;

FIG. 39 is a diagram showing how a portion of a first seal member, once released into an inflow path, rides on a first end portion of an opening edge of the inflow path in a comparative example;

FIG. 40 is a diagram showing how a portion of the first seal member, once released into the inflow path, rides on the first end portion of the opening edge of the inflow path in the first embodiment; and

FIG. 41 is a diagram of the housing seen from the rotary disk side, showing the opening edge of the inflow path and the first seal member in the first embodiment

### MODE FOR CARRYING OUT THE INVENTION

A flow path switching device, which is one example of embodiments of the disclosure will be described below.

### First Embodiment

### Outline of Whole Flow Path Switching Device

The outline of the whole flow path switching device 1 in this embodiment will be described first.

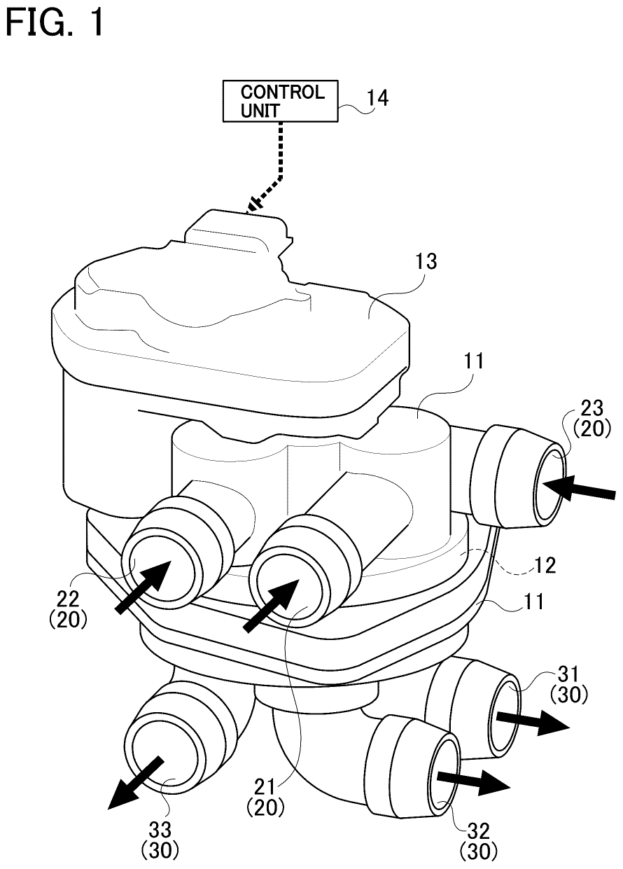

As shown in FIGS. 1 to 3, the flow path switching device 1 includes housings 11, a valve body unit 12, a drive unit 13, and a control unit 14.

The housings 11 are provided with inflow paths 20 in which fluid flows, and outflow paths 30 from which fluid flows out. Herein, the flow path switching device 1 is for example a six-way valve, in which the housings 11 include three inflow paths 20 and three outflow paths 30. As the three inflow paths 20, a first inflow path 21, a second inflow path 22, and a third inflow path 23 are provided. Further, as the three outflow paths 30, a first outflow path 31, a second outflow path 32, and a third outflow path 33 are provided.

The housings 11 are made of resin, for example. The housings 11 are one example of a “fixed member” and a “first fixed member” of the disclosure, and the inflow paths 20 (i.e., the first inflow path 21, second inflow path 22, and third inflow path 23) are one example of a “port”of the disclosure.

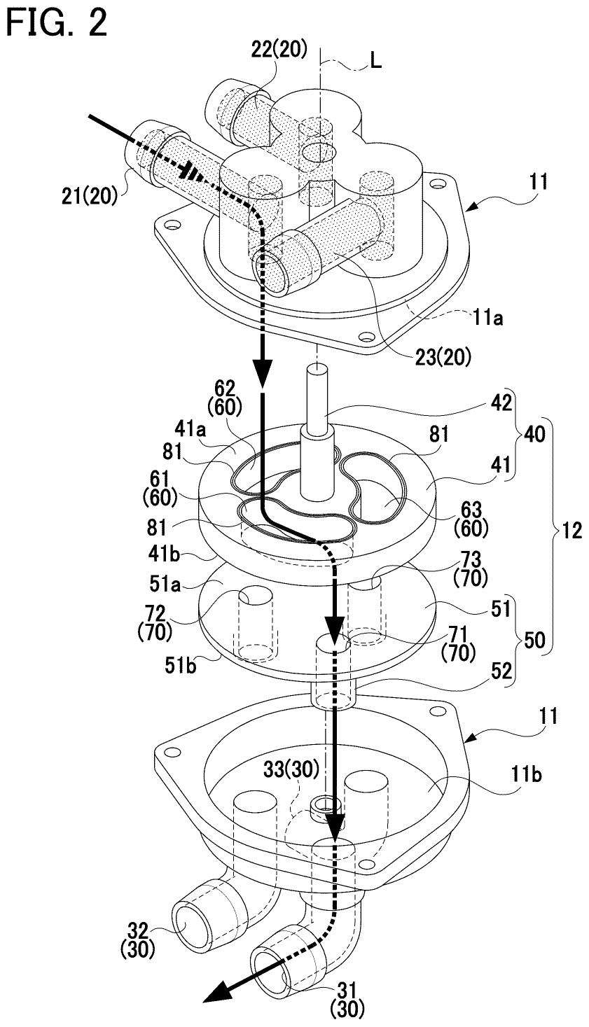

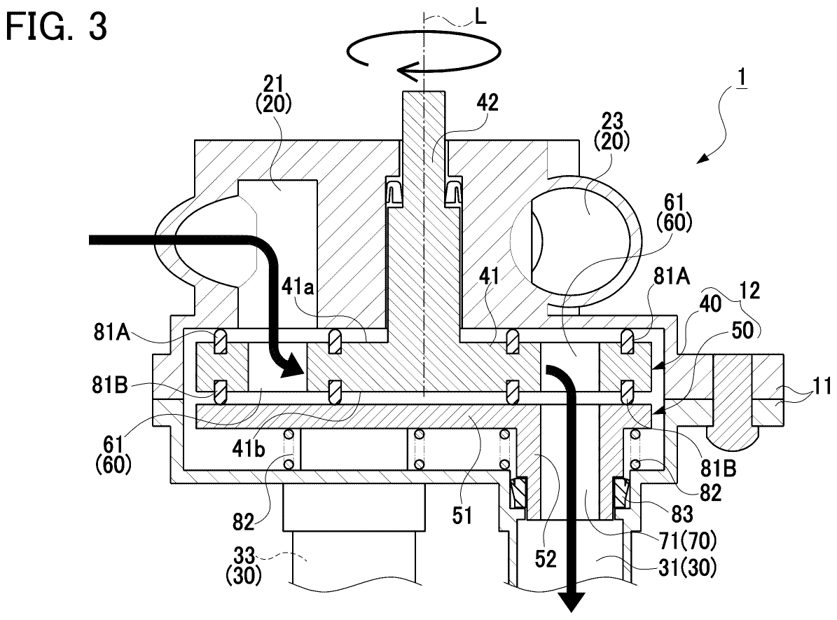

The valve body unit 12 is provided inside the housings 11. This valve body unit 12 is provided with a plate-like rotary disk 40, which is rotatable, and a plate-like fixed disk 50, as shown in FIGS. 2 and 3. The rotary disk 40 and the fixed disk 50 are placed by being stacked in a direction of the central axis L of a circular plate part 41 of the rotary disk 40 and a circular plate part 51 of the fixed disk 50 (hereinafter, simply referred to as an “axial direction”), which will be described later.

The rotary disk 40 and the fixed disk 50 are made of resin, for example. The rotary disk 40 is one example of a “driving member” of the disclosure and the fixed disk 50 is one example of the “fixed member” and a “second fixed member” of the disclosure.

As shown in FIGS. 2 to 4, the rotary disk 40 is placed between the housing 11 and the fixed disk 50 and held between the housing 11 and the fixed disk 50 under the action of stress by the pressing force of disk holding springs 82, which will be mentioned later, via the fixed disk 50 and second seal members 81B, which will be mentioned later. Further, this rotary disk 40 includes the circular plate part 41 and a rotary shaft 42.

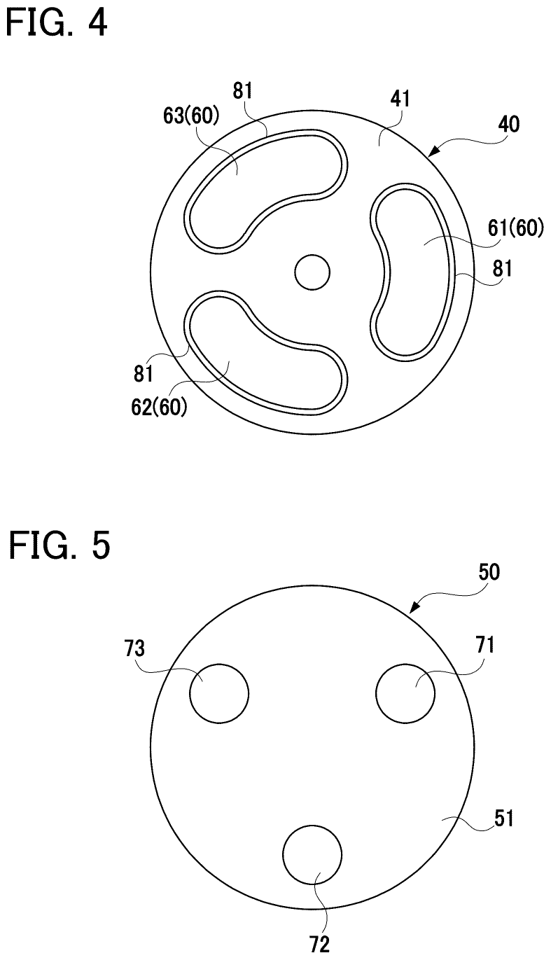

The circular plate part 41 has a circular plate-like shape and includes rotary-disk communication paths 60. These rotary-disk communication paths 60 each extend through the circular plate part 41 in the axial direction and are connectable with the inflow paths 20 and with fixed-disk communication paths 70 which will be mentioned later. Herein, the circular plate part 41 is provided with three rotary-disk communication paths 60. As the three rotary-disk communication paths 60, as shown in FIGS. 2 and 4, a first rotary-disk communication path 61, a second rotary-disk communication path 62, and a third rotary-disk communication path 63 are provided. The rotary-disk communication paths 60 (i.e., the first rotary-disk communication path 61, second rotary-disk communication path 62, and third rotary-disk communication path 63) are one example of a “communication path” of the disclosure.

The rotary shaft 42 is connected, at its one end, to the circular plate part 41 and connected, at its the other end, to the drive unit 13 in the central axis direction. This rotary shaft 42 is positioned in the center of the circular plate part 41 so that the central axis of the rotary shaft 42 coincides with the central axis L of the circular plate part 41. When the rotary shaft 42 is rotated about the central axis by the rotative power transmitted from the drive unit 13, the circular plate part 41 connected to the rotary shaft 42 is rotated about the central axis L. The rotary disk 40 is thus rotated about the central axis L by the rotative power from the drive unit 13.

As shown in FIGS. 2, 3, and 5, the fixed disk 50 includes the circular plate part 51 and cylindrical parts 52.

The circular plate part 51 has a circular plate-like shape and includes fixed-disk communication paths 70 each extending through the circular plate part 51 in the axial direction. Herein, the circular plate part 51 is provided with three fixed-disk communication paths 70. As the three fixed-disk communication paths 70, as shown in FIGS. 2 and 5, a first fixed-disk communication path 71, a second fixed-disk communication path 72, and a third fixed-disk communication path 73 are provided. The fixed-disk communication paths 70 (i.e., the first fixed-disk communication path 71, second fixed-disk communication path 72, and third fixed-disk communication path 73) are one example of the “port”of the disclosure.

The cylindrical parts 52 are connected to the circular plate part 51 and extend from the circular plate part 51 in the axial direction so as to each surround the corresponding one of the fixed-disk communication paths 70. Herein, three cylindrical parts 52 are formed in one-to-one correspondence with the three fixed-disk communication paths 70.

The drive unit 13 is provided with a motor (not shown) to supply rotative power to the rotary shaft 42 of the rotary disk 40.

The control unit 14 is provided with memories, for example, a CPU, a ROM, a RAM, and others, and controls the flow path switching device 1 according to programs stored in advance in the memories.

In the flow path switching device 1 configured as above, the inflow paths 20, the rotary-disk communication paths 60, and the fixed-disk communication paths 70 (the outflow paths 30) are communicated to form flow paths through which fluid flows. The flow path switching device 1 is configured such that the drive unit 13 rotationally drives the rotary disk 40 to switch communication combinations of the inflow paths 20 and the fixed-disk communication path 70 with the rotary-disk communication paths 60 to switch patterns of the flow paths for fluid flow (hereinafter, referred to as a “flow path pattern”).

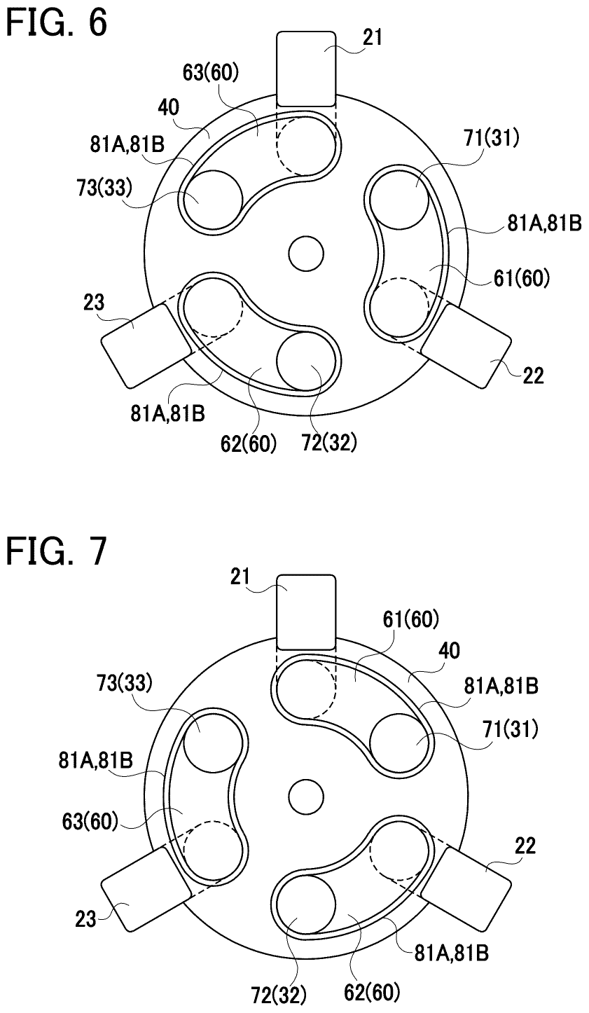

For example, as shown in FIG. 6, in a first flow path pattern, the three rotary-disk communication paths 60 (i.e., the first rotary-disk communication path 61, second rotary-disk communication path 62, and third rotary-disk communication path 63) provide communication between the first inflow path 21 and the third fixed-disk communication path 73 (the third outflow path 33), between the second inflow path 22 and the first fixed-disk communication path 71 (the first outflow path 31), and between the third inflow path 23 and the second fixed-disk communication path 72 (the second outflow path 32).

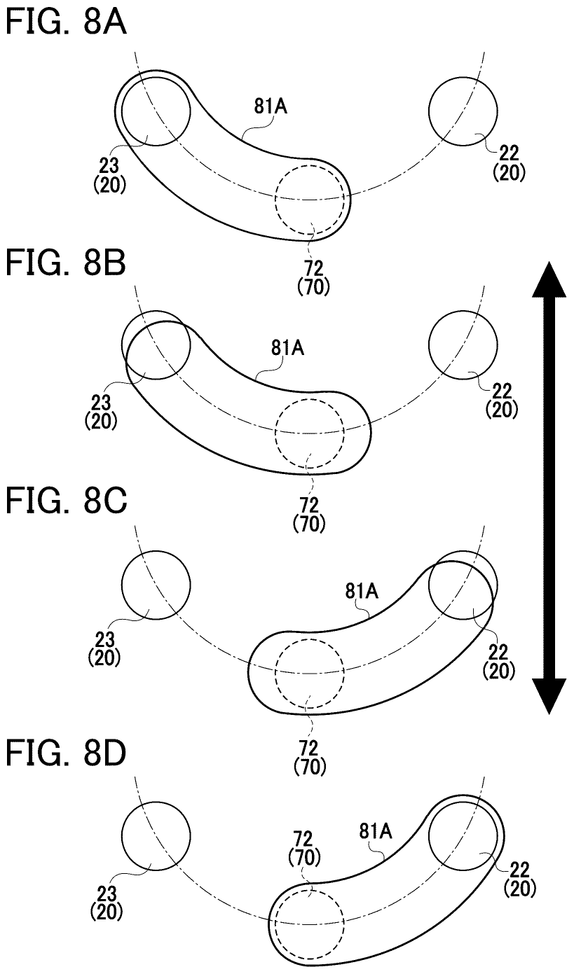

The state of the first flow path pattern shown in FIG. 6 can be switched to a second flow path pattern shown in FIG. 7 by rotating the rotary disk 40 counterclockwise by the drive unit 13.

Specifically, as shown in FIG. 7, in the second flow path pattern, the three rotary-disk communication paths 60 provide communication between the first inflow path 21 and the first fixed-disk communication path 71 (the first outflow path 31), between the second inflow path 22 and the second fixed-disk communication path 72 (the second outflow path 32), and between the third inflow path 23 and the third fixed-disk communication path 73 (the third outflow path 33).

The second flow path pattern shown in FIG. 7 may also be switched to the first flow path pattern shown in FIG. 6 by rotating the rotary disk 40 clockwise by the drive unit 13. The flow path switching device 1 is not limited to the six-way valve and may be any multiple-way valve, such as a three-way valve and a four-way valve.

In the embodiment, elastic members are each provided between the housing 11 and the rotary disk 40, between the rotary disk 40 and the fixed disk 50, and between the fixed disk 50 and the housing 11 in the axial direction.

To be specific, as shown in FIG. 3, first seal members 81A and second seal members 81B are provided as the elastic members between the housing 11 and the rotary disk 40 and between the rotary disk 40 and the fixed disk 50, respectively.

These first seal members 81A and second seal members 81B are placed respectively on an upper surface 41a and a lower surface 41b of the circular plate part 41 of the rotary disk 40 and extend circumferentially to surround the rotary disk communication paths 60 each formed in an elongated hole as shown in FIGS. 2 to 4, and other figures. The first seal members 81A are in contact with the housing 11 and externally seal the flow paths formed between the inflow paths 20 and the rotary-disk communication paths 60 communicated with the inflow paths 20. Further, the second seal members 81B are in contact with the fixed disk 50 and externally seal the flow paths formed between the fixed-disk communication paths 70 and the rotary-disk communication paths 60 communicated with the fixed-disk communication paths 70.

The first seal members 81A and the second seal members 81B are made of, for example, fluororesin (e.g., Teflon (registered trademark)). The first seal members 81A and the second seal members 81B may be made of rubber coated with fluororesin. Further, the first seal members 81A and the second seal members 81B may also be made of any materials other than fluororesin and rubber.

The disk holding springs 82 are provided as the elastic member between the circular plate part 51 of the fixed disk 50 and the housing 11. The stress caused by the pressing force of the disk holding springs 82 acts on the circular plate part 51 of the fixed disk 50. A total of three disk holding springs 82 are provided at positions corresponding to the three cylindrical parts 52 of the fixed disk 50. The three disk holding springs 82 are arranged at equal intervals from each other. The three disk holding springs 82 may also be each arranged between the three cylindrical parts 52. Four or more disk holding springs 82 may also be provided.

Lip seals 83 for securing the sealing performance of the corresponding fixed-disk communication paths 70 are provided between the cylindrical parts 52 of the fixed disk 50 and the housing 11.

### Ensuring Sealing Performance of Seal Member

### Rigidity of Rotary Disk

When the rotary disk 40 is rotated to switch the flow path patterns, the first seal members 81A traverse, or pass across, the inflow paths 20 and thus each have a non-contact portion that is released into the inflow path 20 and does not contact with the housing 11 and a contact portion that contacts with the housing 11. Herein, the first seal member 81A is subjected to the stress by the pressing force of the disk holding spring 82. Thus, local stress may occur in a boundary between the non-contact portion and the contact portion of the first seal member 81A.

To be concrete, when the flow path pattern is switched between a pattern A and a pattern B, the positional relationship between the first seal member 81A and the inflow paths 20 (e.g., the second inflow path 22 and the third inflow path 23) is as shown in FIG. 8. The pattern A is the first flow path pattern shown in FIG. 6 and the pattern B is the second flow path pattern shown in FIG. 7.

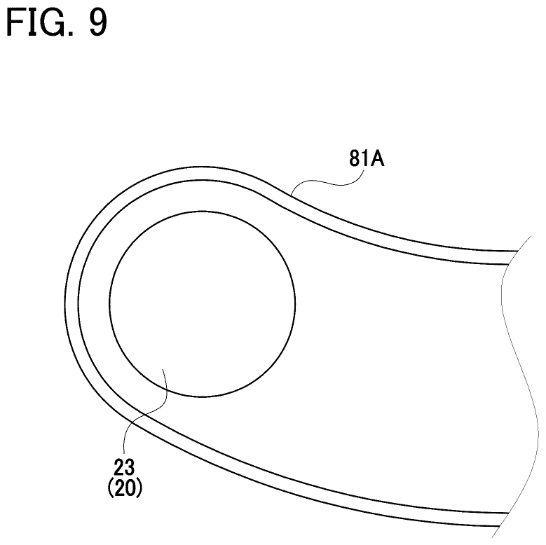

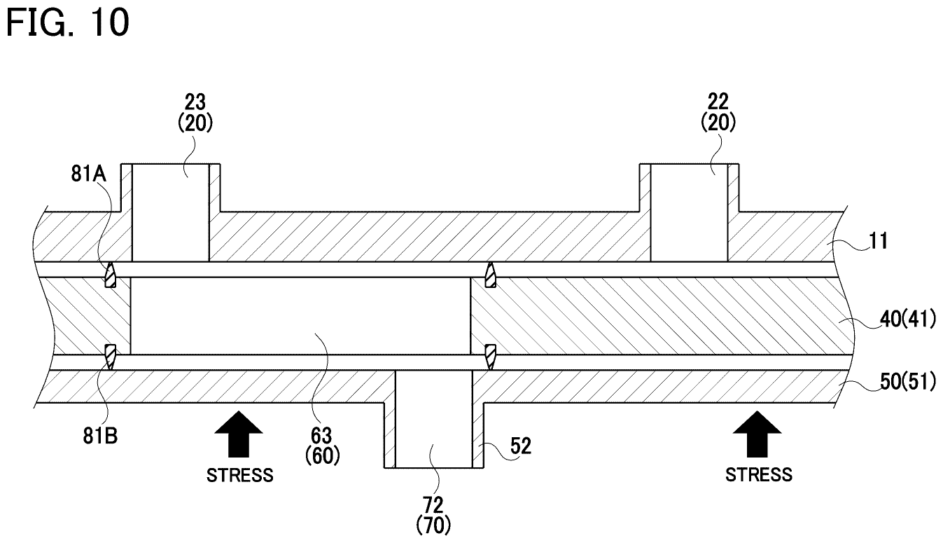

Then, in the state of FIG. 8 (A), the first seal member 81A is not traversing the inflow path 20 (e.g., the third inflow path 23) as shown in FIGS. 9 and 10. Thus, the first seal member 81A is entirely in contact with the housing 11. The whole first seal member 81A is therefore subjected to the stress by the pressing force of the disk holding spring 82 (see FIG. 10) via the fixed disk 50, the second seal member 81B, and the rotary disk 40.

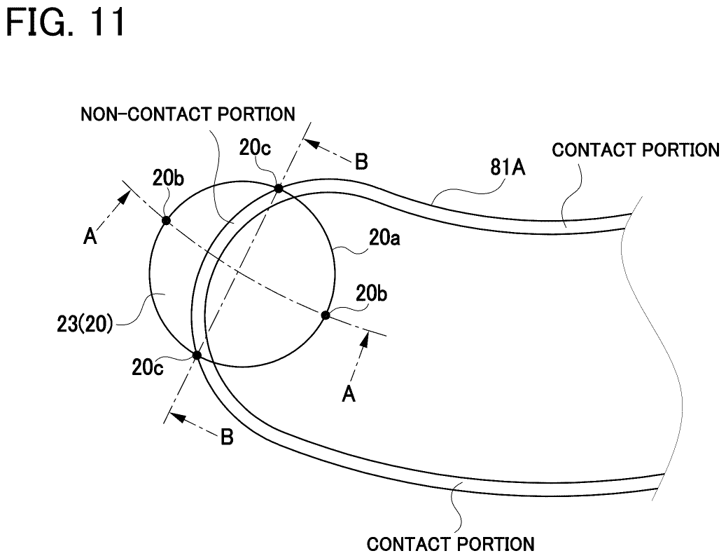

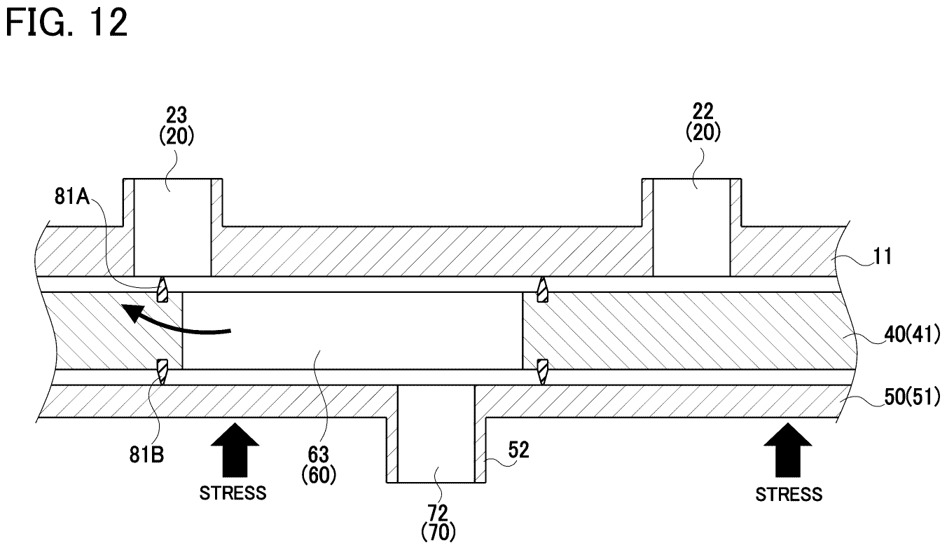

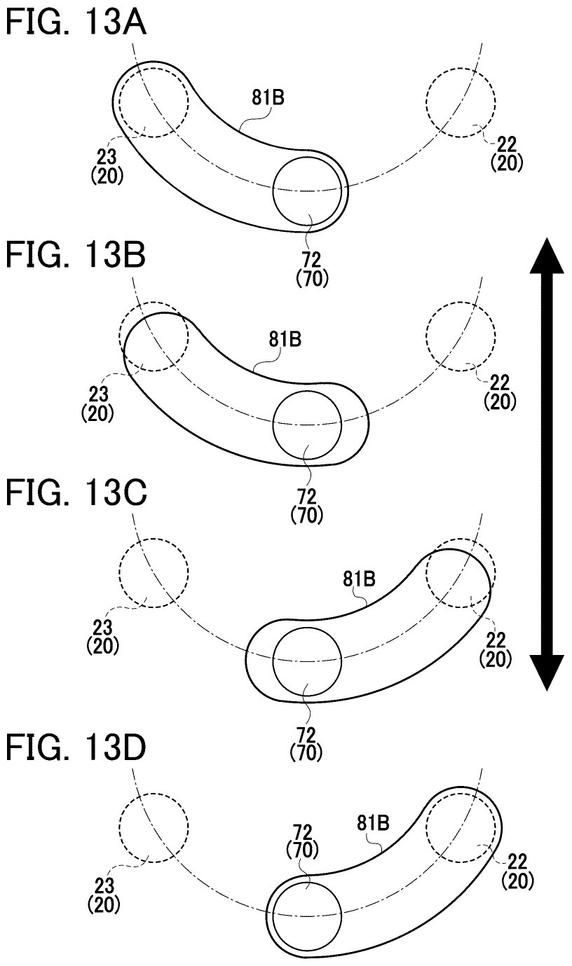

However, in the state of FIG. 8 (B), the first seal member 81A is traversing the inflow path 20 (e.g., the third inflow path 23) as shown in FIGS. 11 and 12. Thus, the first seal member 81A has a non-contact portion that is once released into the inflow path 20 and does not contact with the housing 11 and a contact portion that contacts with the housing 11 as shown in FIG. 11.

This first seal member 81A is subjected to the stress by the pressing force of the disk holding spring 82 via the fixed disk 50, the second seal member 81B, and the rotary disk 40 as shown in FIG. 12. Thus, the rotary disk 40 is displaced due to the release of stress on the non-contact portion (of the first seal member 81A) as illustrated by an arrow, which will be hereinafter referred to as “displacement due to stress release”.

As this displacement due to stress release becomes larger, it becomes more difficult for the first seal member 81A provided in the rotary disk 40 to maintain its posture. This may cause large stress to locally occur in the boundary between the non-contact portion and the contact portion of the first seal member 81A. Thus, the first seal member 81A is prone to wear and crack, which may deteriorate the sealing performance of the first seal member 81A.

In the embodiment, therefore, the rotary disk 40 is made to be highly rigid and difficult to bend in order to reduce the displacement due to stress release. Concretely, the thickness of the rotary disk 40 is made larger than the thickness of the fixed disk 50 so that the rotary disk 40 has a higher rigidity than the fixed disk 50.

Since the rotary disk 40 is highly rigid and less deformable as above, the displacement of the rotary disk 40 due to stress release can be reduced, so that the posture of the first seal member 81A provided in the rotary disk 40 can be maintained. This configuration can prevent large local stress from occurring in the boundary between the non-contact portion and the contact portion of the first seal member 81A. Consequently, the first seal member 81A can be prevented from wearing and cracking, and hence can ensure the sealing performance.

### Second Seal Member

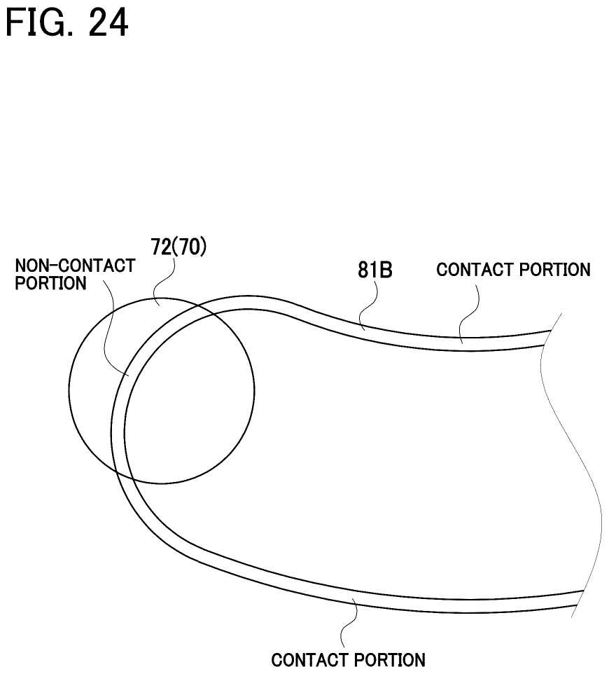

When the rotary disk 40 is rotated to switch the flow path patterns, the second seal member 81B traverses, or pass across, the fixed-disk communication path 70 (e.g., the second fixed-disk communication path 72) and thus has a non-contact portion that is once released into the first fixed-disk communication path 71 and does not contact with the fixed disk 50 and a contact portion that contacts with the fixed disk 50 as shown in FIG. 24.

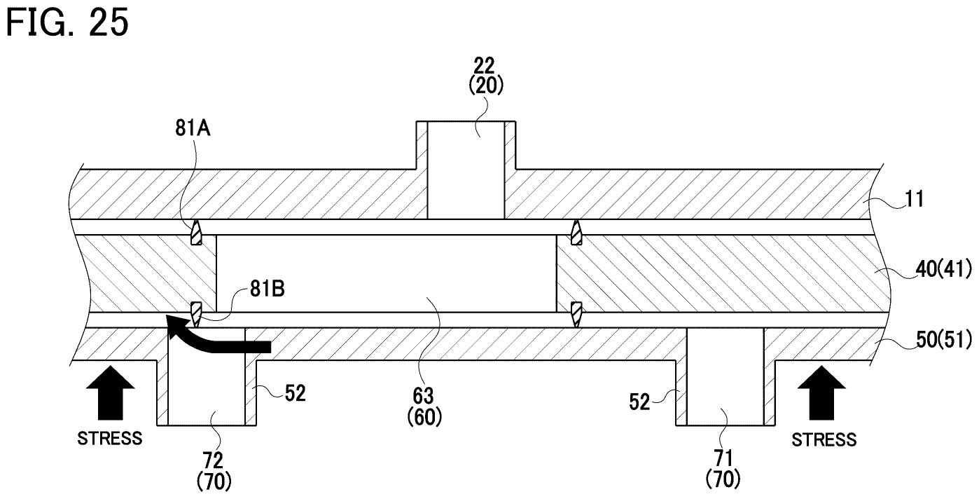

The fixed disk 50 is subjected to the stress by the pressing force of the disk holding spring 82 as shown in FIG. 25, and thus the fixed disk 50 is displaced due to stress release as illustrated by an arrow. Herein, since the fixed disk 50 has a thin thickness and a low rigidity, the displacement due to stress release is made large, which may cause large stress to locally occur in the boundary between the non-contact portion and the contact portion of the second seal member 81B. Thus, the second seal member 81B is prone to wear and crack, which may deteriorate the sealing performance of the second seal member 81B.

Furthermore, the stress acting on the rotary disk 40 by the pressing force of the disk holding spring 82 also decreases, which may deteriorate the sealing performance of the first seal member 81A provided in the rotary disk 40.

In the embodiment, therefore, when the rotary disk 40 is rotated to switch the flow path pattern between the pattern A and the pattern B, the second seal member 81B does not traverse the fixed-disk communication path 70 (e.g., the second fixed-disk communication path 72) of the fixed disk 50 as shown in FIG. 13. Specifically, the fixed-disk communication paths 70 of the fixed disk 50 are arranged at positions where the second seal members 81B do not traverse when the flow path pattern is switched between the pattern A and the pattern B by rotation of the rotary disk 40.

Accordingly, when the flow path pattern between the pattern A and the pattern B is switched by rotating the rotary disk 40, the second seal members 81B do not traverse the fixed-disk communication paths 70 of the fixed disk 50. This configuration can prevent deformation of the fixed disk 50. Thus, the fixed disk 50 can be designed with a reduced thickness (with lower rigidity). Furthermore, this configuration can prevent large local stress from occurring in the boundary between the non-contact portion and the contact portion of each second seal member 81B due to deformation of low-rigid fixed disk 50, so that the second seal members 81B can be prevented from wearing and cracking. Thus, the sealing performance can be ensured.

### Opening Edge of Inflow Path

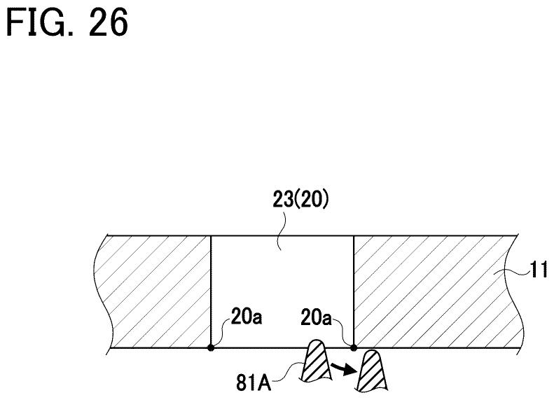

When the first seal member 81A traverses the inflow path 20, the non-contact portion of the first seal member 81A eventually rides up from inside to outside of the inflow path 20 and comes into contact with the housing 11. At that time, as shown in FIG. 26, an edge 20a of an opening, i.e., an opening edge 20a, of the inflow path 20 of the housing 11 becomes a step, on which the non-contact portion of the first seal member 81A is caught, which may cause the first seal member 81A to wear and crack.

Thus, the opening edge 20a of the inflow path 20 of the housing 11, on the side facing the rotary disk 40, may be formed with R (a curve shape).

However, if the R is formed with a constant size over the entire circumference of the edge 20a, the diameter of the edge 20a will increase over the entire circumference, leading to an increase in size of the housing 11. Therefore, the size of R is changed depending on the circumferential position in the edge 20a.

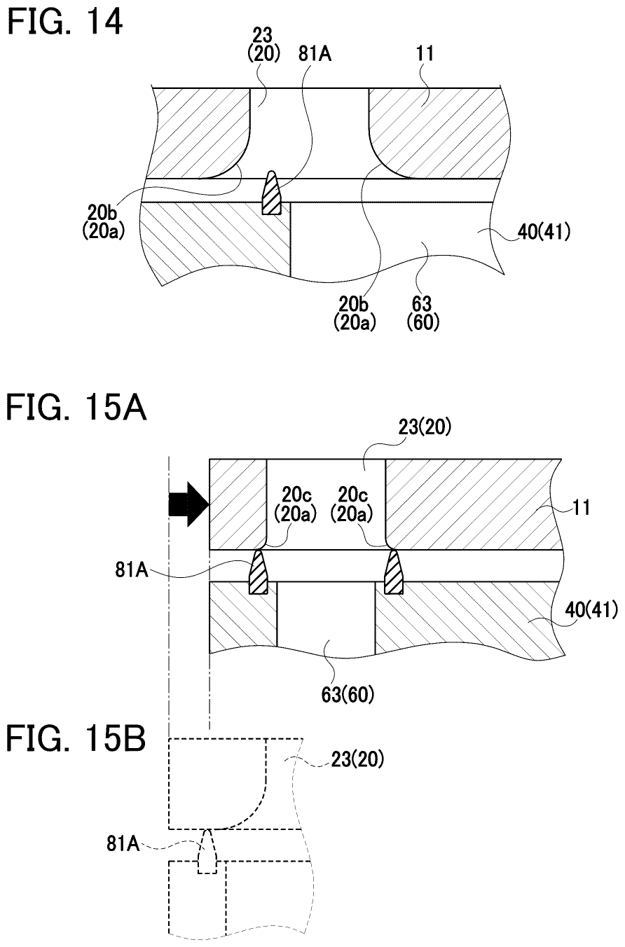

Specifically, as shown in FIGS. 14 and 15(a), the size of R is larger at a position of a first end portion 20b (see FIG. 11), which is an end point of the opening edge 20a in the rotation direction of the rotary disk 40 than at a position of a second end portion 20c (see FIG. 11), which is an end point in a direction perpendicular (or nearly perpendicular) to the rotation direction of the rotary disk 40. The size of R is gradually smaller from the first end portion 20b toward the second end portion 20c in the circumferential direction of the edge 20a. When the size of R of the first end portion 20b is assumed as 2 mm, for example, the size of R of the second end portion 20c is 0.5 mm. The “rotation direction” is one example of a “driving direction”of the disclosure.

Accordingly, while the first seal member 81A traverses the inflow path 20 of the housing 11, when the non-contact portion of the first seal member 81A is less likely to get caught on the opening edge 20a of the inflow path 20 when moving out of the inflow path 20 and coming into contact with the housing 11. Therefore, the first seal member 81A can be prevented from wearing and cracking. Thus, the sealing performance of the first seal member 81A can be ensured.

Further, the size of R of the edge 20a varies from position to position in its circumferential direction, which can prevent an increase in size of the housing 11. For example, the size of R is reduced at the position of the second end portion 20c, so that the size of the housing 11 can be made smaller than in the case shown in FIG. 15(b) (i.e., in the case where the R is large).

The opening edge 20a of the inflow path 20 on the side facing the rotary disk 40 may be formed with a taper, instead of formed with R. Moreover, in a configuration that the second seal members 81B traverse the fixed-disk communication paths 70, as shown in FIGS. 24 and 25, the opening edge of each fixed-disk communication path 70 on the side facing the rotary disk 40 may be formed with R or a taper.

### First Control for Rotation Speed of Rotary Disk

As the first control for the rotation speed of the rotary disk 40, in switching the flow path patterns by rotating the rotary disk 40, the rotation speed of the rotary disk 40 may be controlled to slow down when the first seal members 81A traverse the inflow paths 20 of the housing 11. This allows the boundary between the non-contact portion and the contact portion of each first seal member 81A, where stress concentrically occurs, to gradually shift. Thus, the first seal members 81A can be prevented from wearing and cracking.

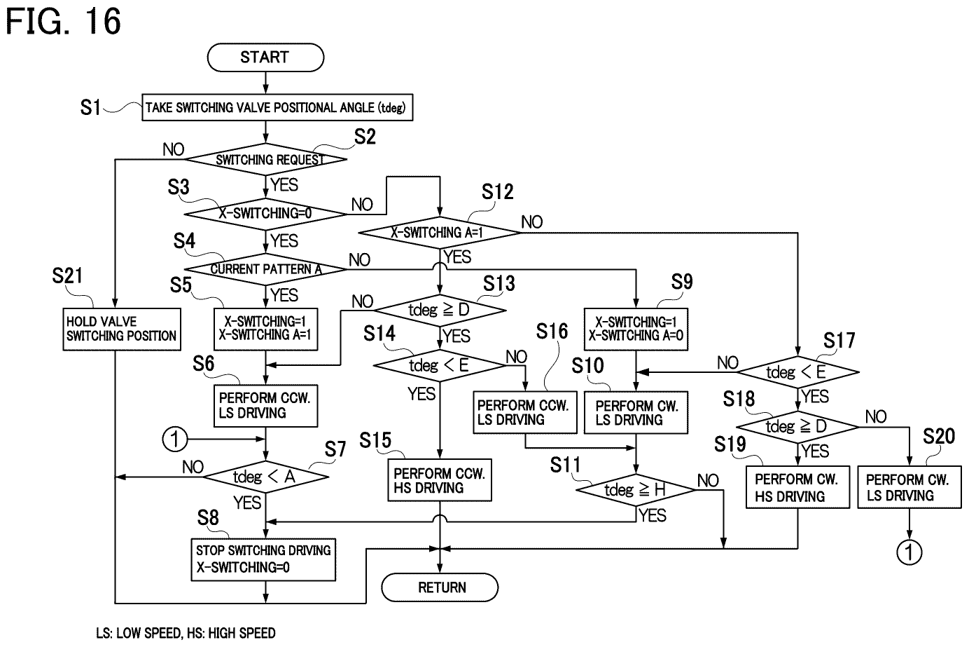

Specifically, the control unit 14 executes the control contents shown in FIG. 16 as the first control for the rotation speed of the rotary disk 40.

As shown in FIG. 16, the control unit 14 takes a switching valve positional angle tdeg (step S1) and determines whether or not a request of switching flow path patterns is present (step S2).

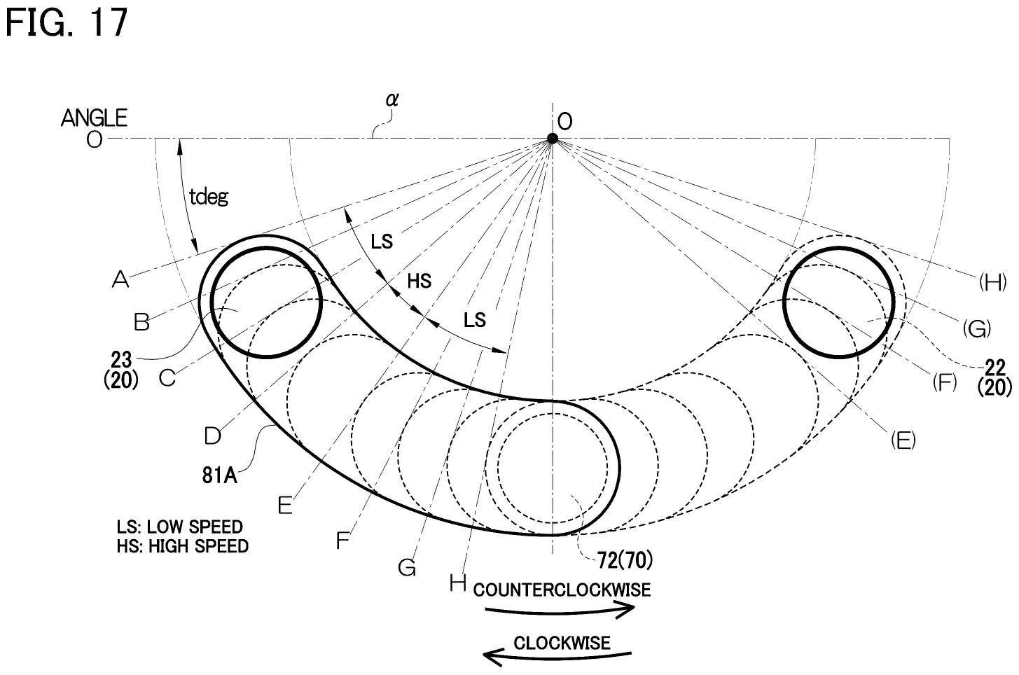

Herein, the “switching valve positional angle tdeg” indicates the position of the first seal member 81A in the rotation direction of the rotary disk 40. To be specific, the “switching valve positional angle tdeg” represents, as shown in FIG. 17, the angle formed between the line α at angle 0 and the line connecting the most rearward portion of the first seal member 81A during counterclockwise rotation of the rotary disk 40 (i.e., the most frontward portion of the first seal member 81A during clockwise rotation of the rotary disk 40) and the position of the rotation center O of the rotary disk 40. The control unit 14 obtains detection values of the rotation angle of the rotary disk 40 from an angle sensor not shown.

When the flow path pattern switching request is present (step S2: YES), the control unit 14 determines whether or not a switching flag (X-switching) is 0 (step S3).

When the switching flag is 0 (step S3: YES), in order to start flow path switching, the control unit 14 determines whether the pattern is a current pattern A, that is, the current flow path pattern is the pattern A (step S4). Herein, the pattern A is the first flow path pattern shown in FIG. 6.

When the pattern is the current pattern A (step S4: YES), in order to rotate the rotary disk 40 counterclockwise to switch the flow pattern from the pattern A to the pattern B, the control unit 14 turns the switching flag and a switching A flag (X-switching A) to 1 (step S5) and performs counterclockwise (ccw.) low-speed driving of the rotary disk 40 (step S6). In other words, the control unit 14 rotates the rotary disk 40 counterclockwise at low speed. Herein, the “low speed” is the lower speed than a normal speed for switching flow path patterns, e.g., a ½ speed of the normal speed, and is one example of a “first low speed” of the disclosure.

Then, the control unit 14 determines whether or not the switching valve positional angle tdeg is less than an angle A (see FIG. 17) (step S7).

When the switching valve positional angle tdeg is less than the angle A (step S7: YES), the control unit 14 stops the switching driving, i.e., stops the rotation of the rotary disk 40 an turns the switching flag to 0 (step S8).

In contrast, when the switching valve positional angle tdeg is the angle A or more (step S7: NO), the control unit 14 continues to rotate the rotary disk 40 counterclockwise at low speed.

When the pattern is not the current pattern A in step S4 (step S4: NO), that is, when the current flow path pattern is the pattern B, the control unit 14 turns the switching flag to 1 and the switching A flag to 0 (step S9) to switch the flow path pattern from the pattern B to the pattern A by rotating the rotary disk 40 clockwise. Herein, the pattern B is the second flow path pattern shown in FIG. 7.

Subsequently, the control unit 14 performs clockwise (cw.) low-speed driving of the rotary disk 40 (step S10). In other words, the control unit 14 rotates the rotary disk 40 clockwise at low speed.

The control unit 14 then determines whether or not the switching valve positional angle tdeg is an angle H (see FIG. 17) or more (step S11).

When the switching valve positional angle tdeg is the angle H or more (step S11: YES), the control unit 14 stops the switching driving and turns the switching flag to 0 (step S8).

In contrast, when the switching valve positional angle tdeg is less than the angle H (step S11: NO), the control unit 14 continues to rotate the rotary disk 40 clockwise at low speed.

When the switching flag is 1 in step 3 (step S3: NO), indicating that the flow path patterns have been switched, the control unit 14 determines whether or not the switching A flag is 1 (step S12).

When the switching A flag is 1 (step S12: YES), where the rotary disk 40 is being rotated counterclockwise to switch the flow path pattern from the pattern A to the pattern B, the control unit 14 determines whether or not the switching valve positional angle tdeg is an angle D (see FIG. 17) or more (step 13).

When the switching valve positional angle tdeg is the angle D or more (step S13: YES), the control unit 14 determines whether or not the switching valve positional angle tdeg is less than an angle E (see FIG. 17) (step S14).

When the switching valve positional angle tdeg is less than the angle E (step S14: YES), the control unit 14 performs counterclockwise high-speed driving of the rotary disk 40 (step S15). In other words, the control unit 14 rotates the rotary disk 40 counterclockwise at high speed.

In this way, as shown in FIG. 17, when the switching valve positional angle tdeg is the angle D or more and further less than the angle E when the flow path pattern is switched from the pattern A to the pattern B by rotating the rotary disk 40 counterclockwise, that is, when the first seal member 81A is not traversing the inflow path 20 (e.g., the second inflow path 22 or third inflow path 23), the rotary disk 40 is rotated counterclockwise at high speed. Herein, the “high speed” is the normal speed for switching the flow path patterns.

In contrast, when the switching valve positional angle tdeg is the angle E or more (step S14: NO), the control unit 14 performs counterclockwise low-speed driving of the rotary disk 40 (step S16), and determines whether or not the switching valve positional angle tdeg is the angle H or more (step S11).

When the switching valve positional angle tdeg is less than the angle D (step S13: NO), the control unit 14 performs counterclockwise low-speed driving of the rotary disk 40 (step S6). In other words, the control unit 14 rotates the rotary disk 40 counterclockwise at low speed.

In this way, as shown in FIG. 17, during counterclockwise rotation of the rotary disk 40, when the switching valve positional angle tdeg is the angle A or more and further less than the angle D, and, the switching valve positional angle tdeg is the angle E or more and further less than the angle H, that is, when the first seal member 81A is traversing the inflow path 20 (e.g., the second inflow path 22 or third inflow path 23), the rotary disk 40 is rotated counterclockwise at low speed.

When the switching A flag is 0 (step S12: NO) in step 12, that is, when the rotary disk 40 is being rotated clockwise to switch the flow path pattern from the pattern B to the pattern A, the control unit 14 determines whether or not the switching valve positional angle tdeg is less than the angle E (step S17).

When the switching valve positional angle tdeg is less than the angle E (step S17: YES), the control unit 14 determines whether or not the switching valve positional angle tdeg is the angle D or more (step S18).

When the switching valve positional angle tdeg is the angle D or more (step S18: YES), the control unit 14 performs clockwise high-speed driving of the rotary disk 40 (step S19). In other words, the control unit 14 rotates the rotary disk 40 clockwise at high speed.

In contrast, when the switching valve positional angle tdeg is less than the angle D (step S18: NO), the control unit 14 performs the clockwise low-speed driving of the rotary disk 40 (step 20), and determines whether or not the switching valve positional angle tdeg is less than the angle A (step S7).

In this way, as shown in FIG. 17, in switching the flow path pattern from the pattern B to the pattern A by rotating the rotary disk 40 clockwise, when the switching valve positional angle tdeg is the angle D or more and further less than the angle E, that is, when the first seal member 81A is not traversing the inflow path 20 (e.g., the second inflow path 22 or third inflow path 23), the rotary disk 40 is rotated clockwise at high speed.

In contrast, when the switching valve positional angle tdeg is the angle E or more (step S17: NO), the control unit 14 performs clockwise low-speed driving of the rotary disk 40 (step S10). In other words, the control unit 14 rotates the rotary disk 40 clockwise at low speed.

In this way, as shown in FIG. 17, in switching the flow path pattern from the pattern B to the pattern A by rotating the rotary disk 40 clockwise, when the switching valve positional angle tdeg is the angle E or more and further less than the angle H or when the angle switching valve positional angle tdeg is the angle A or more and further less than the angle D, that is, when the first seal member 81A is traversing the inflow path 20 (e.g., the second inflow path 22 or third inflow path 23), the control unit 14 rotates the rotary disk 40 clockwise at low speed.

When the flow path pattern switching request is not present in step S2 (step S2: NO), the control unit 14 holds a valve switching position (step S19), that is, maintains the stop position of the rotary disk 40 as it is.

During execution of the above-described control to rotate the rotary disk 40 counterclockwise to switch the flow path pattern from the pattern A to the pattern B, as shown in FIG. 17, when the switching valve positional angle tdeg is the angle A or more and further less than the angle D and when the switching valve positional angle tdeg is the angle E or more and further less than the angle H, the rotary disk 40 is rotated counterclockwise at low speed. In contrast, when the switching valve positional angle tdeg is the angle D or more and further less than the angle E, the rotary disk 40 is rotated counterclockwise at high speed.

Specifically, in switching the flow path pattern from the pattern A to the pattern B, the rotary disk 40 is rotated counterclockwise at low speed while the first seal member 81A is traversing the inflow path 20, whereas the rotary disk 40 is rotated counterclockwise at high speed while the first seal member 81A is not traversing the inflow path 20.

Further, in switching the flow path pattern from the pattern B to the pattern A by rotating the rotary disk 40 clockwise, when the switching valve positional angle tdeg is the angle E or more and further less than the angle H and when the switching valve positional angle tdeg is the angle A or more and further less than the angle D, the rotary disk 40 is rotated clockwise at low speed. In contrast, when the switching valve positional angle tdeg is the angle D or more and further less than the angle E, the rotary disk 40 is rotated clockwise at high speed.

Specifically, in switching the flow path pattern from the pattern B to the pattern A, the rotary disk 40 is rotated clockwise at low speed while the first seal member 81A is traversing the inflow path 20, whereas the rotary disk 40 is rotated clockwise at high speed while the first seal member 81A is not traversing the inflow path 20.

In this way, in switching the flow path pattern between the pattern A and the pattern B by rotating the rotary disk 40, the rotary disk 40 rotates at low speed while the first seal members 81A are traversing the inflow paths 20, whereas the rotary disk 40 rotates at high speed while the first seal members 81A are not traversing the inflow path 20.

When switching the flow path patterns by rotating the rotary disk 40, as described above, the control unit 14 sets the rotation speed of the rotary disk 40 to a low speed while the first seal members 81A is traversing the inflow paths 20.

Accordingly, as the first seal members 81A pass across the inflow paths 20, an area where local stress occurs in each first seal member 81A is gradually shifted. This can prevent each first seal member 81A from wearing and cracking. Thus, the sealing performance of each first seal member 81A can be ensured.

The first control for the rotation speed of the rotary disk 40 may also be applied to the situation where the second seal members 81B are traversing the fixed-disk communication paths 70 of the fixed disk 50.

### Second Control for Rotation Speed of Rotary Disk

As the second control for the rotation speed of the rotary disk 40, in switching the flow path patterns by rotating the rotary disk 40, the rotation speed of the rotary disk 40 may be controlled to further slow down when the first seal members 81A shift from the state of traversing the inflow paths 20 of the housing 11 to the state of not traversing the inflow paths 20.

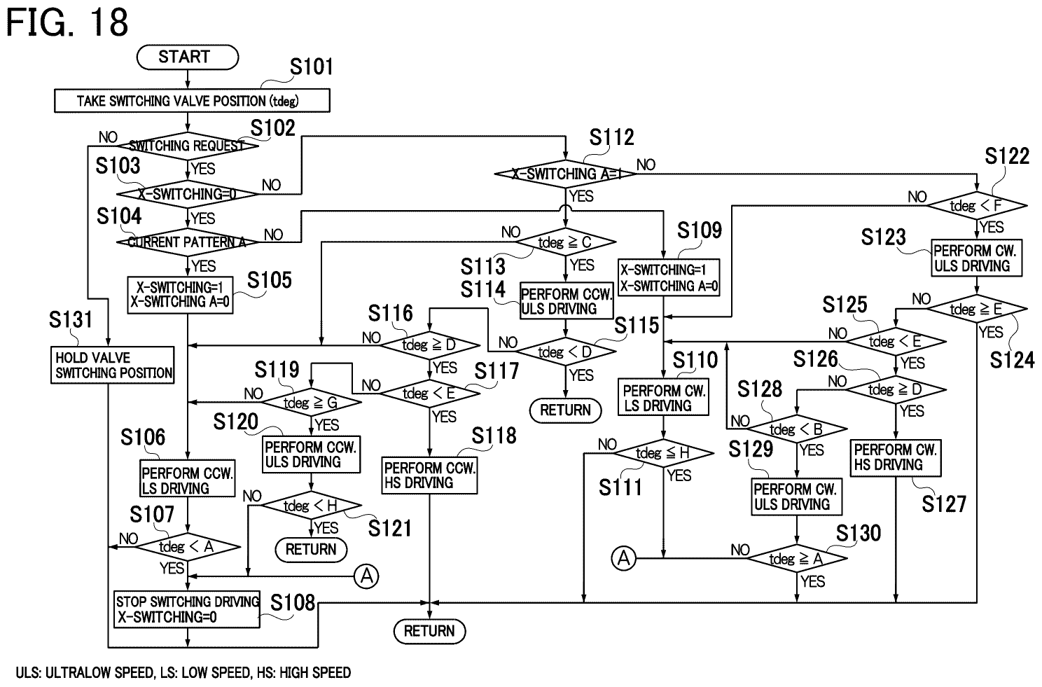

Specifically, the control unit 14 executes the control contents shown in FIG. 18 as the second control for the rotation speed of the rotary disk 40. In the following description, only different matters from the contents of the first control for the rotation speed of the rotary disk 40 shown in FIG. 16 will be described.

As shown in FIG. 18, when the switching A flag is 1 in step 112 (step S112: YES), that is, when the rotary disk 40 is rotated counterclockwise to switch the flow path pattern from the pattern A to the pattern B, the control unit 14 determines whether or not the switching valve positional angle tdeg is an angle C or more (step S113).

When the switching valve positional angle tdeg is the angle C or more (step S113: YES), the control unit 14 performs counterclockwise ultralow-speed driving of the rotary disk 40 (step S114). In other words, the control unit 14 rotates the rotary disk 40 counterclockwise at ultralow speed. Herein, the “ultralow speed” is a slower speed than the low speed, e.g., a ⅓ speed of the normal speed, and is one example of a “second low speed”of the disclosure.

Then, the control unit 14 determines whether or not the switching valve positional angle tdeg is less than the angle D (step S115).

When the switching valve positional angle tdeg is less than the angle D (step S 115: YES), the control unit 14 continues to rotate the rotary disk 40 counterclockwise at ultralow speed.

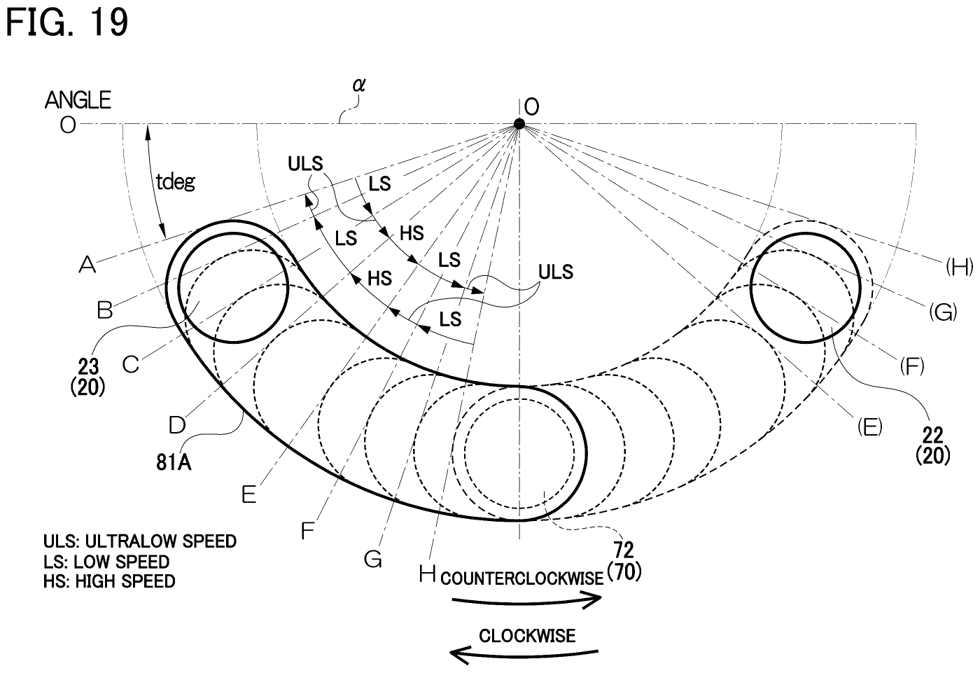

In this way, as shown in FIG. 19, in switching the flow path pattern from the pattern A to the pattern B by rotating the rotary disk 40 counterclockwise, when the switching valve positional angle tdeg is the angle C or more and further less than the angle D, that is, when the first seal member 81A (its rearward portion in the moving direction, which is a portion located between the angle C and the angle D) shifts from the state of traversing the inflow path 20 (e.g., the third inflow path 23) of the housing 11 to the state of not traversing the inflow path 20, the control unit 14 rotates the rotary disk 40 counterclockwise at ultralow speed.

When the switching valve positional angle tdeg is the angle E or more in step S117 (step S117: NO), the control unit 14 determines whether or not the switching valve positional angle tdeg is an angle G or more (step S119).

When the switching valve positional angle tdeg is the angle G or more (step S119: YES), the control unit 14 performs counterclockwise ultralow-speed driving (step S120). In other words, the control unit 14 rotates the rotary disk 40 counterclockwise at ultralow speed.

The control unit 14 then determines whether or not the switching valve positional angle tdeg is less than the angle H (step S121).

When the switching valve positional angle tdeg is less than the angle H (step S121: YES), the control unit 14 continues to rotate the rotary disk 40 counterclockwise at ultralow speed.

In this way, as shown in FIG. 19, in switching the flow path pattern from the pattern A to the pattern B by rotating the rotary disk 40 counterclockwise, when the switching valve positional angle tdeg is the angle G or more and further less than the angle H, that is, when the first seal member 81A (its frontward portion in the moving direction, which is a portion located between the angle (G) and the angle (H)) shifts from the state of traversing the inflow path 20 (e.g., the second inflow path 22) of the housing 11 to the state of not traversing the inflow path 20, the control unit 14 rotates the rotary disk 40 counterclockwise at ultralow speed.

When the switching A flag is 0 in step 112 (step S112: NO), that is, when the rotary disk 40 is rotated clockwise to switch the flow path pattern from the pattern B to the pattern A, the control unit 14 determines whether or not the switching valve positional angle tdeg is less than an angle F (step S122).

When the switching valve positional angle tdeg is less than the angle F (step S122: YES), the control unit 14 performs clockwise ultralow-speed driving of the rotary disk 40 (step S123). In other words, the control unit 14 rotates the rotary disk 40 clockwise at ultralow speed.

The control unit 14 then determines whether or not the switching valve positional angle tdeg is the angle E or more (step S124).

When the switching valve positional angle tdeg is the angle E or more (step S124: YES), the control unit 14 continues to rotate the rotary disk 40 clockwise at ultralow speed.

In this way, as shown in FIG. 19, in switching the flow path pattern from the pattern B to the pattern A by rotating the rotary disk 40 clockwise, when the switching valve positional angle tdeg is the angle E or more and further less than the angle F, that is, when the first seal member 81A (its rearward portion in the moving direction, which is a portion located between the angle (E) and the angle (F)) shifts from the state of traversing the inflow path 20 (e.g., the second inflow path 22) of the housing 11 to the state of not traversing the inflow path 20, the control unit 14 rotates the rotary disk 40 clockwise at ultralow speed.

When the switching valve positional angle tdeg is less than the angle D in step S126 (step S126: NO), the control unit 14 determines whether or not the switching valve positional angle tdeg is less than the angle B (step S128).

When the switching valve positional angle tdeg is less than the angle B (step S128: YES), the control unit 14 performs clockwise ultralow-speed driving of the rotary disk 40 (step S129). In other words, the control unit 14 rotates the rotary disk 40 clockwise at ultralow speed.

The control unit 14 then determines whether or not the switching valve positional angle tdeg is the angle A or more (step S130).

When the switching valve positional angle tdeg is the angle A or more (step S130: YES), the control unit 14 continues to rotate the rotary disk 40 clockwise at ultralow speed.

In this way, as shown in FIG. 19, in switching the flow path pattern from the pattern B to the pattern A by rotating the rotary disk 40 clockwise, when the switching valve positional angle tdeg is the angle A or more and further less than the angle B, that is, when the first seal member 81A (its frontward portion in the moving direction, which is a portion located between the angle A and the angle B) shifts from the state of traversing the inflow path 20 (e.g., the third inflow path 23) of the housing 11 to the state of not traversing the inflow path 20, the control unit 14 rotates the rotary disk 40 clockwise at ultralow speed.

When switching the flow path patterns by rotating the rotary disk 40, as described above, the control unit 14 sets the rotation speed of the rotary disk 40 to an ultralow speed slower than the low speed while the first seal members 81A are shifting from the state of traversing to the state of not traversing the inflow paths 20 of the housing 11.

Accordingly, while the first seal members 81A are shifting from the state of traversing to the state of not traversing the inflow paths 20 of the housing 11, that is, when the non-contact portion of each first seal member 81A, which is released into the inflow path 20 of the housing 11 and out of contact with the housing 11, shifts from inside to outside of the inflow path 20 of the housing 11 and rides on the contact surface with the housing 11, an area where local stress occurs in each first seal member 81A is gradually shifted. This can more effectively prevent the first seal members 81A from wearing and cracking, and thus can more effectively ensure the sealing performance.

The second control for the rotation speed of the rotary disk 40 may also be applied to the situation where the second seal members 81B are traversing the fixed-disk communication paths 70 of the fixed disk 50.

### Sliding Flow Path Switching Device

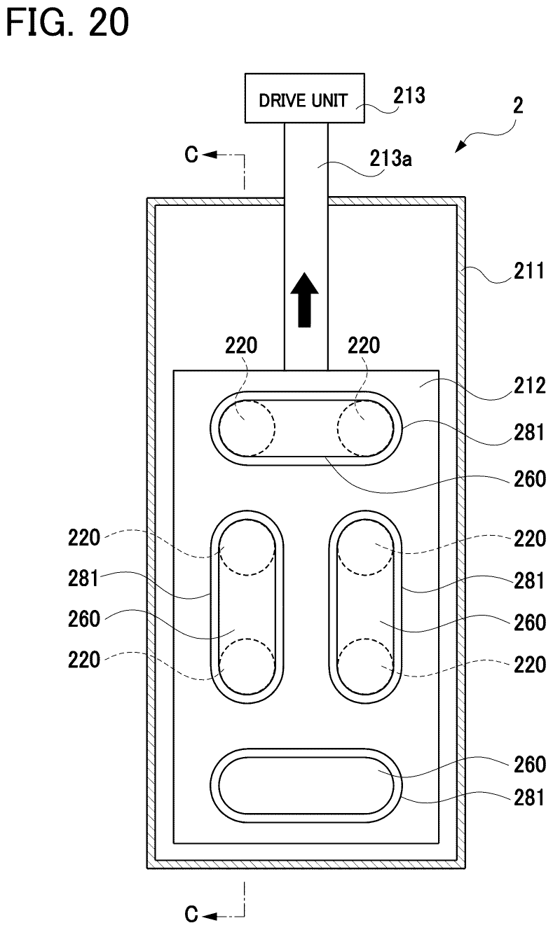

The above-described details of the disclosure are also applicable to a flow path switching device 2 shown in FIGS. 20 to 23. The flow path switching device 2 includes a housing 211, a slide valve 212, and a drive unit 213, as shown in FIGS. 20 to 23.

The housing 211 is provided with flow path ports 220 through which fluid flows in or out. Herein, the flow path switching device 2 is a six-way valve as one example, and the housing 211 is provided with six flow path ports 220. The housing 211 is made of resin, for example, and is one example of the “fixed member” of the disclosure. The flow path ports 220 are one example of the “port” of the disclosure.

The slide valve 212 is provided inside the housing 211. The slide valve 212 is made of resin, for example, and is one example of the “driving member” of the disclosure.

The slide valve 212 has a rectangular plate-like shape (i.e., a nearly rectangular parallelepiped shape) and is provided with at least one slide-valve communication path 260. Herein, as one example, the slide valve 212 is provided with four slide-valve communication paths 260. The slide-valve communication paths 260 are one example of the “communication path”of the disclosure.

The drive unit 213 is provided with an actuator (not shown) to supply drive power to drive the slide valve 212.

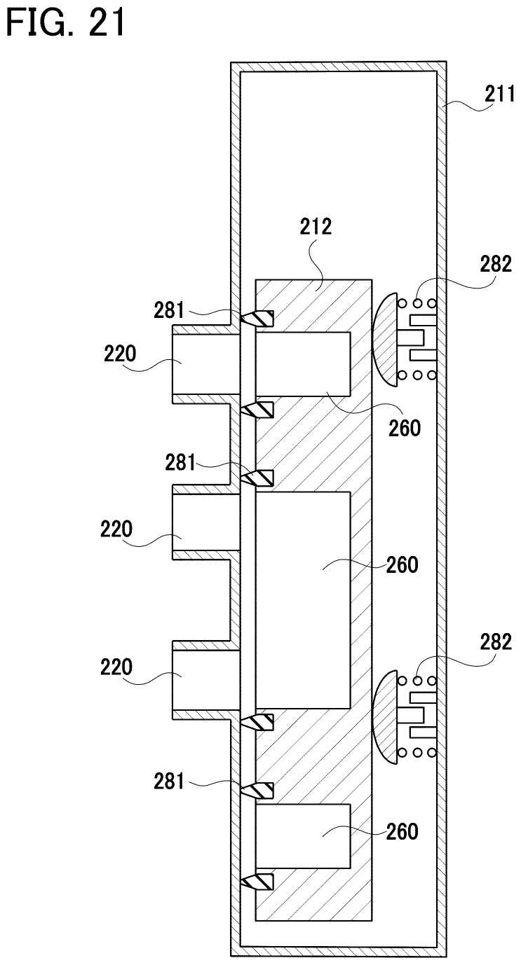

As shown in FIG. 21, seal members 281 are provided between the housing 211 and the slide valve 212. Further, the slide valve 212 is subjected to the action of stress by the biasing force of springs 282.

The seal members 281 are made of, for example, fluororesin (e.g., Teflon (registered trademark)). The seal members 281 may be made of rubber coated with fluororesin. Further, the seal members 281 may also be made of any materials other than fluororesin and rubber.

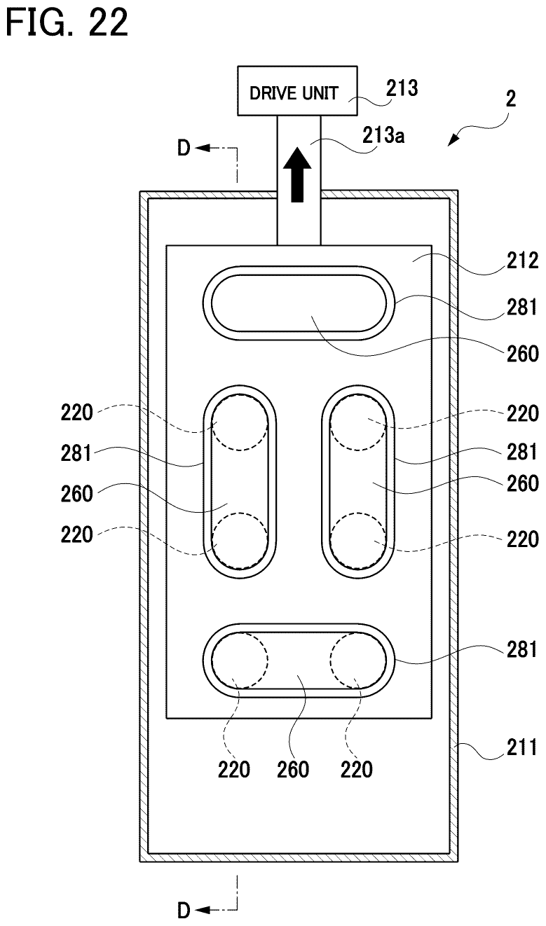

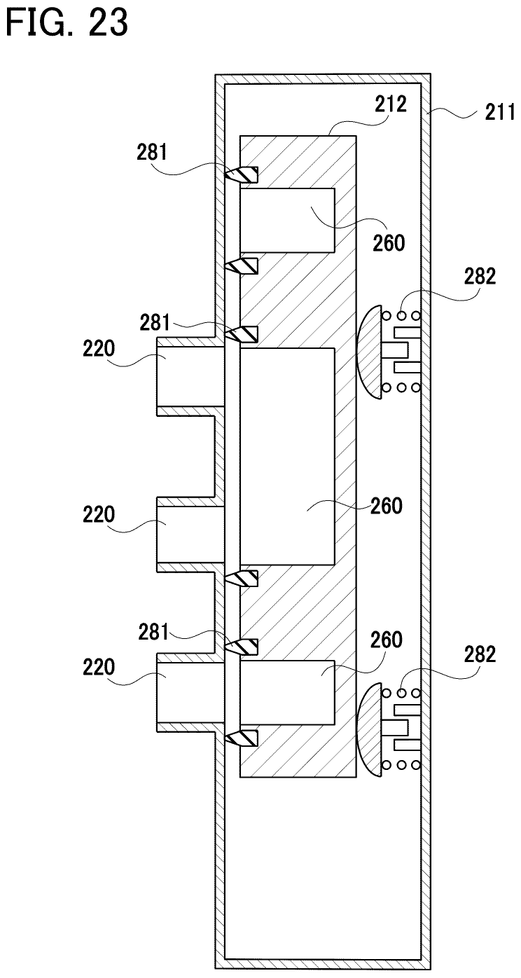

In the flow path switching device 2 configured as above, the flow path ports 220 of the housing 211 and the slide-valve communication paths 260 are combined to form flow paths. The flow path switching device 2 is configured such that a drive shaft 213a of the drive unit 213 drives the slide valve 212 to slide in an axial direction of the drive shaft 213a to change communication combinations of the flow path ports 220 with the slide-valve communication paths 260 to switch the flow path pattern between a first flow path pattern shown in FIGS. 20 and 21 and a second flow path pattern shown in FIGS. 22 and 23.

In the thus configured flow path switching device 2, the slide valve 212 is more highly rigid than the housing 211.

The opening edge of each flow path port 220 of the housing 211, on a side facing the slide valve 212, may also be formed with R or a taper as in the flow path switching device 1.

When the slide valve 212 is slid to switch the flow path patterns, the driving speed (the sliding speed) of the slide valve 212 may also be set to a lower speed than the normal speed while the seal members 281 are traversing the flow path ports 220 of the housing 211.

Furthermore, in switching the flow path patterns by sliding the slide valve 212, the driving speed of the slide valve 212 may also be set to an ultralow speed slower than the low speed while the seal members 281 are shifting from the state of traversing the flow path ports 220 of the housing 211 to the state of not traversing.

### Second Embodiment

Next, a second embodiment will be described, focusing on on different matters from the first embodiment, and omitting the details of similar matters to the first embodiment. Herein, the description is made on the flow path switching device 1.

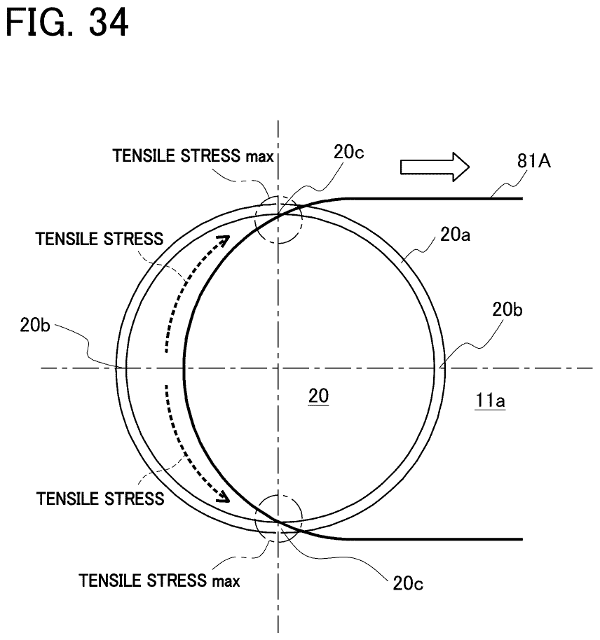

It is assumed that the rotary disk 40 rotates and the first seal member 81A moves between the first end portion 20b on the opposite side (a left side in the figure) to the rotation direction (a rightward direction in the figure) of the rotary disk 40 and the second end portions 20c, from the first end portion 20b toward the second end portions 20c, as shown in FIG. 34.

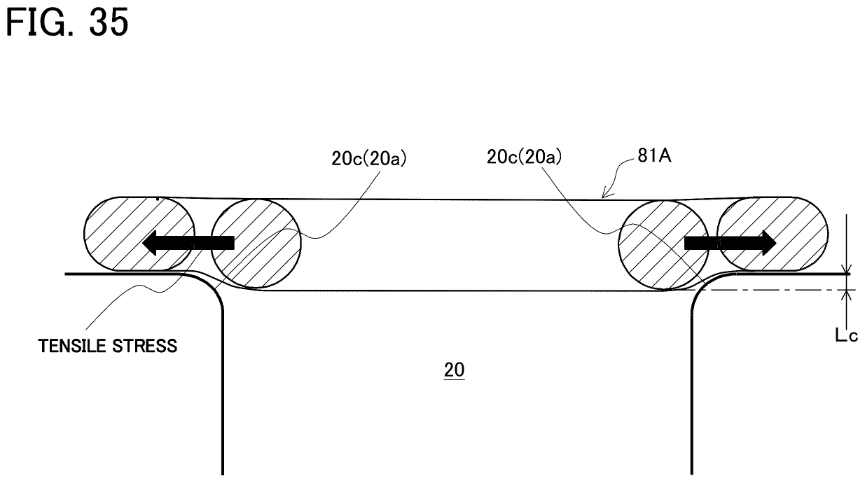

At that time, as shown in FIG. 35, a portion of the first seal member 81A, which is once released into the inflow path 20, that is, the length of a non-contact portion released into the inflow path 20 and thus does not contact with the housing 11 (hereinafter, simply referred to as a “non-contact portion with the housing 11” as appropriate) gradually increases, in which tensile stress occurs. Further, at that time, in the first seal member 81A, the protruding amount Lc of the non-contact portion with the housing 11, which protrudes into the inflow path 20, is as shown in FIG. 35. The tensile stress is max at the position of each second end portion 20c as shown in FIG. 34.

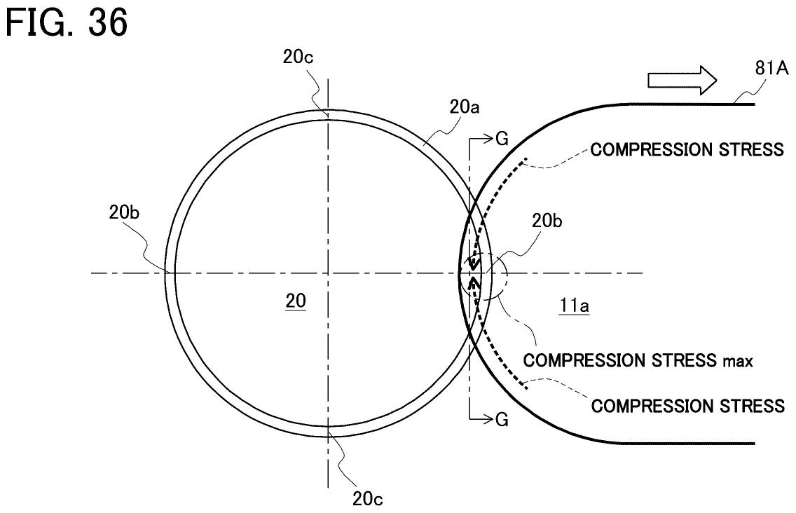

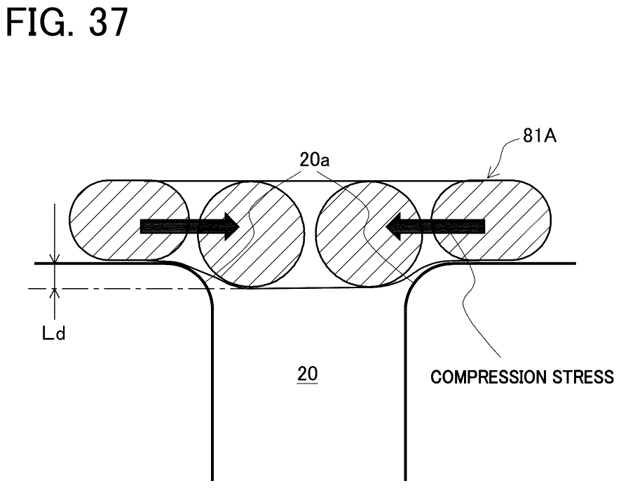

It is assumed that the rotary disk 40 then rotates and the first seal member 81A moves between the second end portions 20c and the first end portion 20b on the forward side in the rotation direction (a right side in the figure) of the rotary disk 40, from the second end portions 20c toward the first end portion 20b, as shown in FIG. 36.

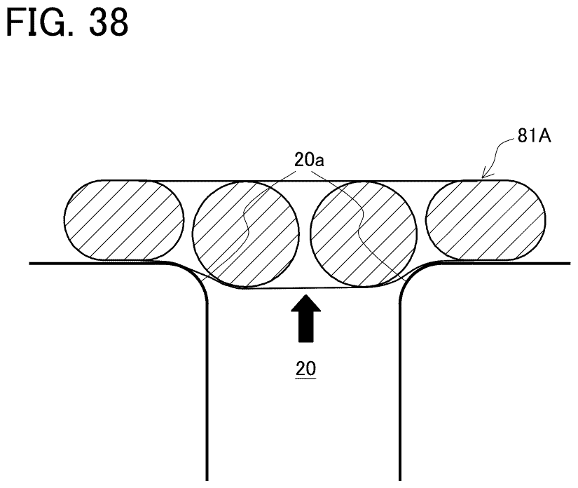

At that time, as shown in FIG. 37, in the first seal member 81A, the length of the non-contact portion with the housing 11 gradually decreases, in which compression stress occurs. Further, in the first seal member 81A, the protruding amount Ld of the non-contact portion with the housing 11, which protrudes into the inflow path 20, is as shown in FIG. 37. This protruding amount Ld is larger than the protruding amount Lc (see FIG. 35). As shown in FIG. 36, the compression stress is max at the position of the first end portion 20b on the forward side in the rotation direction of the rotary disk 40.

Thereafter, as the rotary disk 40 rotates, the non-contact portion of the first seal member 81A with the housing 11 is pushed up by the opening edge 20a, riding on the first end portion 20b of the opening edge 20a. Subsequently, the first seal member 81A slides from the opening edge 20a to the surface 11a of the housing 11 on the side facing the rotary disk 40.

In the embodiment, the opening edge 20a of each inflow path 20 of the housing 11, on the side facing the rotary disk 40, is formed with R (a curve shape). The size of R (i.e., the radius of R) is larger at the position of each first end portion 20b of the opening edge 20a than at the position of each second end portion 20c of the opening edge 20a. The opening edge 20a may be formed with a taper instead of R. In this case, the size of the taper is a taper inclination angle.

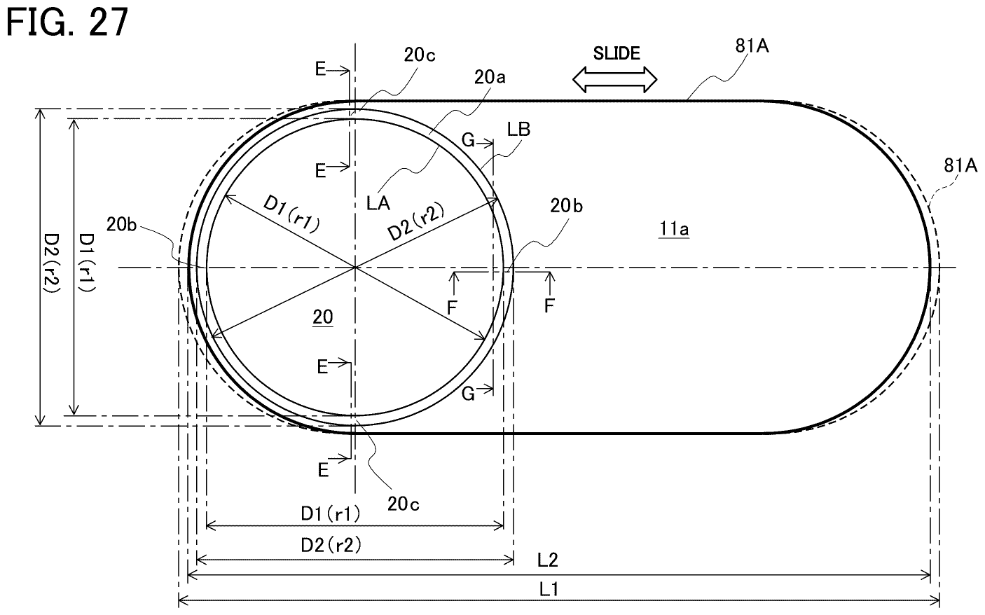

In the embodiment, as shown in FIG. 27, the inner periphery LA and the outer periphery LB of the opening edge 20a formed circumferentially are each formed in a circular shape. To be specific, the inner periphery LA is formed in a circular shape with a diameter D1 and the outer periphery LB is formed in a circular shape with a diameter D2. The diameter D2 is larger than the diameter D1. In FIG. 27 and others, for the purpose of illustration, the moving direction of the rotary disk 40 is shown as the lateral direction of the figures.

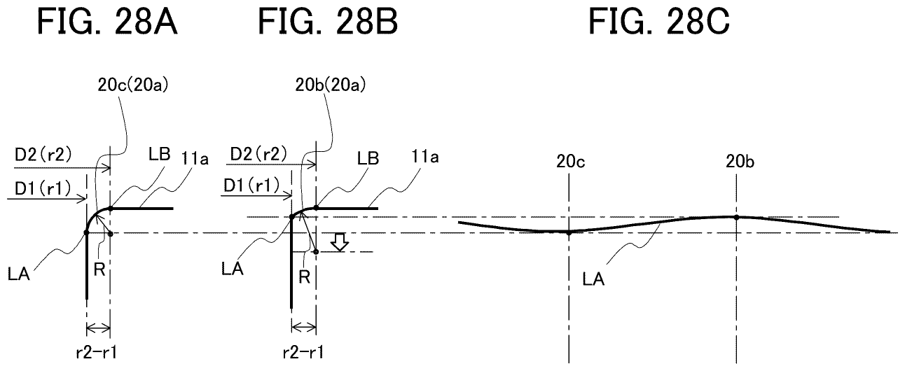

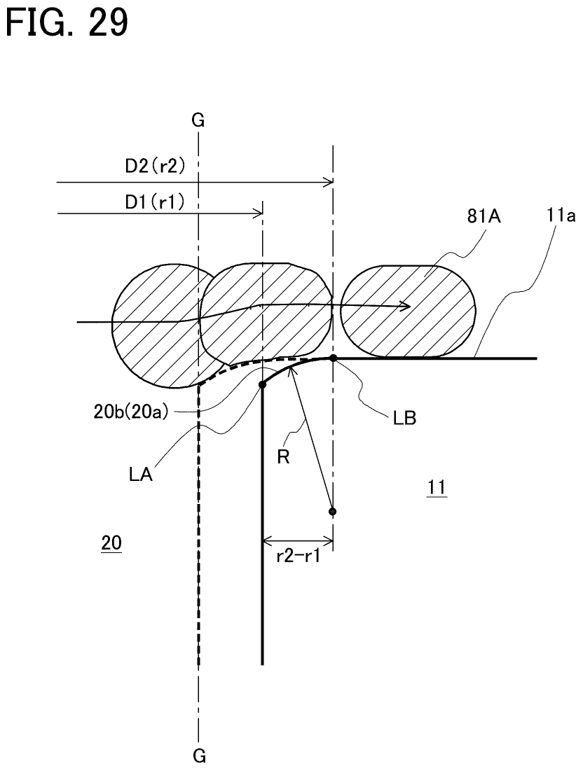

In the embodiment, as described above, as shown in FIGS. 27 and 28, the radius r1 of the inner periphery LA of the opening edge 20a and the radius r2 of the outer periphery LB of the opening edge 20a at the first end portion 20b of the opening edge 20a are equal or approximately equal to those at the second end portion 20c of the opening edge 20a.

The radius r1 of the inner periphery LA of the opening edge 20a is an opening radius of the opening portion. The radius r2 of the outer periphery LB of the opening edge 20a is a radius of a boundary between the R of the opening edge 20a and the surface 11a of the housing 11.

In the embodiment, as shown in FIG. 28(B), the position of the center of R of the first end portion 20b is deviated (i.e., offset) to the lower side in the figure (i.e., to the opposite side to the opening portion of the inflow path 20) relative to the center of R of the second end portion 20c shown in FIG. 28(A), so that the size of R of the first end portion 20b is made large without increasing the radius r2 of the outer periphery LB of the opening edge 20a.

In this way, in the embodiment, while the size of R is set larger at the first end portion 20b than at the second end portion 20c, the radius r1 of the inner periphery LA of the opening edge 20a at the first end portion 20b and the radius r1 of the inner periphery LA of the opening edge 20a at the second end portion 20c are set equal or approximately equal. In addition, the radius r2 of the outer periphery LB of the opening edge 20a at the first end portion 20b and the radius r2 of the outer periphery LB of the opening edge 20a at the second end portion 20c are set equal or approximately equal.

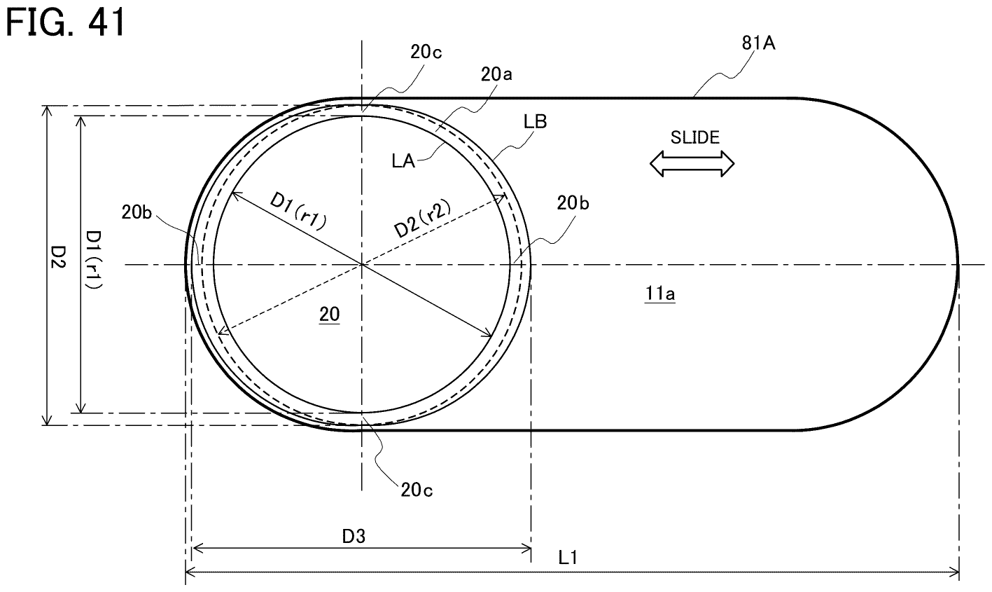

In the embodiment, accordingly, as shown in FIG. 29, the position of the inner periphery LA of the opening edge 20a is positioned on an upper side in the figure (i.e., on the side toward which the first seal member 81A is pushed up) more than in the first embodiment (see FIG. 40).

Accordingly, during rotation of the rotary disk 40 relative to the housing 11 to switch the flow path patterns, when the first seal member 81A passes across the inflow path 20, as shown in FIG. 29, the non-contact portion of the first seal member 81A with the housing 11 can be pushed up onto a portion of the opening edge 20a near the first end portion 20b (a portion indicated with a dotted line G-G in the figure, corresponding to portions located on a line G-G in FIG. 27) to ride on the first end portion 20b. Thus, the non-contact portion of the first seal member 81A with the housing 11 can be effectively pushed up. This allows the non-contact portion of the first seal member 81A with the housing 11 to smoothly ride up on the first end portion 20b of the opening edge 20a. Therefore, the first seal member 81A can smoothly pass across the inflow path 20.

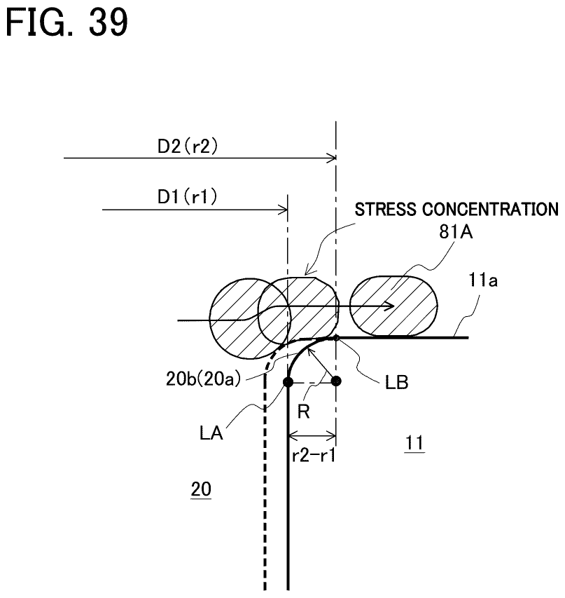

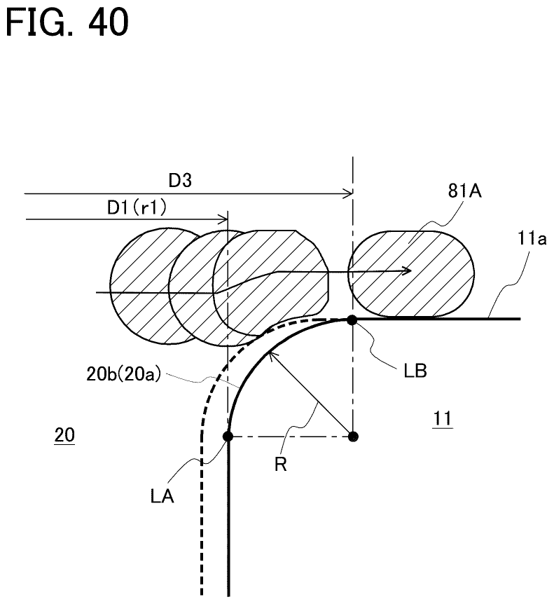

In the comparative example shown in FIG. 39, in which the size of R of the first end portion 20b is equal to the size of R of the second end portion 20c, the non-contact portion of the first seal member 81A with the housing 11 cannot smoothly run up on the first end portion 20b of the opening edge 20a just before riding on the first end portion 20b. Thus, stress is likely to concentrate due to compression stress.

However, according to the present embodiment, the size of R is set larger at the first end portion 20b than at the second end portion 20c, suppressing concentration of stress due to compressive stress in the non-contact portion of the first seal member 81A with the housing 11, just before the non-contact portion of the first seal member 81A with the housing 11 rides on the first end portion 20b of the opening edge 20a. According to the embodiment, therefore, the non-contact portion of the first seal member 81A with the housing 11 can smoothly ride on the first end portion 20b of the opening edge 20a than in the comparative example shown in FIG. 39.

Furthermore, according to the embodiment, as compared with the first embodiment shown in FIG. 40, it is possible to effectively push up the non-contact portion of the first seal member 81A with the housing 11 in riding on the first end portion 20b of the opening edge 20a. According to the embodiment, therefore, the non-contact portion of the first seal member 81A with the housing 11 is allowed to smoothly ride on the opening edge 20a than in the first embodiment shown in FIG. 40.

Moreover, according to the embodiment, as shown in FIG. 29, the size of R of the first end portion 20b is larger than (r2−r1). This value (r2−r1) is obtained by subtracting the radius r1 of the inner periphery LA of the opening edge 20a from the radius r2 of the outer periphery LB of the opening edge 20a. In the embodiment, as described above, the size of R is reliably large at the first end portion 20b of the opening edge 20a. This configuration more reliably enables to effectively push up the first seal member 81A when the non-contact portion of the first seal member 81A with the housing 11 rides on the first end portion 20b of the opening edge 20a. In addition, the first seal member 81A can be prevented from wearing.

As shown in FIG. 27, the distance (corresponding to D2 in the figure) between the two first end portions 20b in the present embodiment can be set smaller than the distance (D3 in FIG. 41) between the two first end portions 20b in the first embodiment shown in FIG. 41.

Thus, the length L2 of the first seal member 81A in the present embodiment (i.e., the length in the rotation direction of the rotary disk 40) can be made shorter than the length L1 of the first seal member 81A in the first embodiment. This can reduce sliding resistance between the first seal member 81A and the housing 11 and suppress an increase in rotating torque of the rotary disk 40.

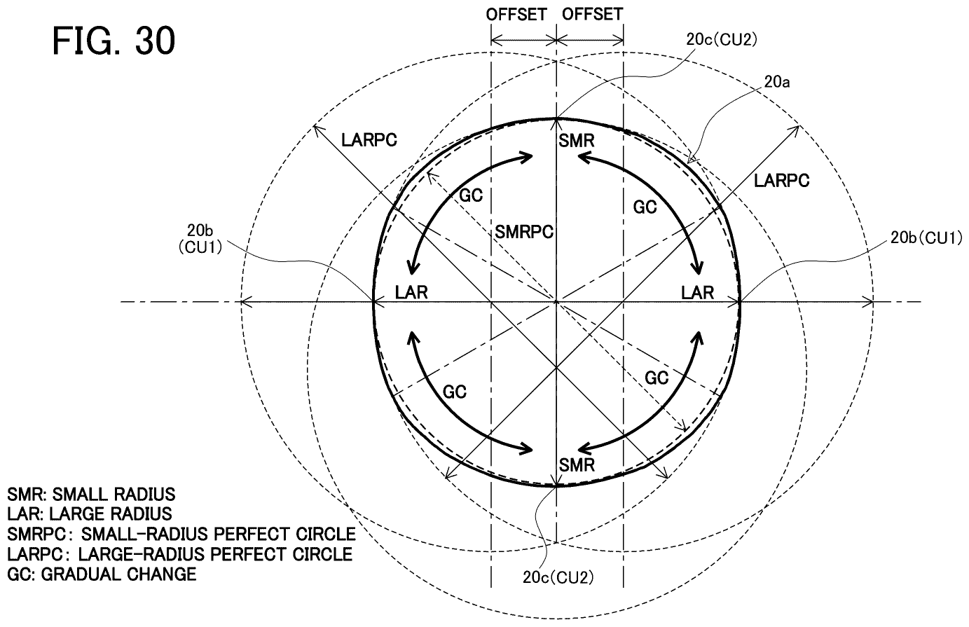

As a first variant example, as shown in FIG. 30, the shape of the opening edge 20a when seen from the rotary disk 40 side may also be a flattened circular shape. Specifically, the opening edge 20a may be shaped such that a first opening curvature CU1, which is a curvature of the first end portion 20b, is smaller than a second opening curvature CU2, which is a curvature of the second end portion 20c. In other words, as shown in FIG. 30, the opening edge 20a may be shaped such that the curvature radius at the second end portion 20c is small as a small radius, while the curvature radius at the first end portion 20b is large as a large radius.

The curvature of the shape of the opening edge 20a gradually changes (makes gradual change) from the second end portion 20c toward the first end portion 20b so as to gradually decrease (i.e., the curvature radius of the shape of the opening edge 20a gradually changes so as to gradually increase).

In the first variant example, as described above, the opening edge 20a is shaped with a small curvature at the first end portion 20b (i.e., with a small first opening curvature CU1).

Accordingly, while the first seal member 81A is traversing the inflow path 20 by rotating the rotary disk 40 relative to the housing 11, the compression stress acting on the first seal member 81A is reduced just before the non-contact portion of the first seal member 81A with the housing 11 rides on the first end portion 20b of the opening edge 20a. Thus, the protruding amount of the non-contact portion of the first seal member 81A with the housing 11 into the inflow path 20 is reduced. This allows the first seal member 81A to smoothly ride on the first end portion 20b of the opening edge 20a.

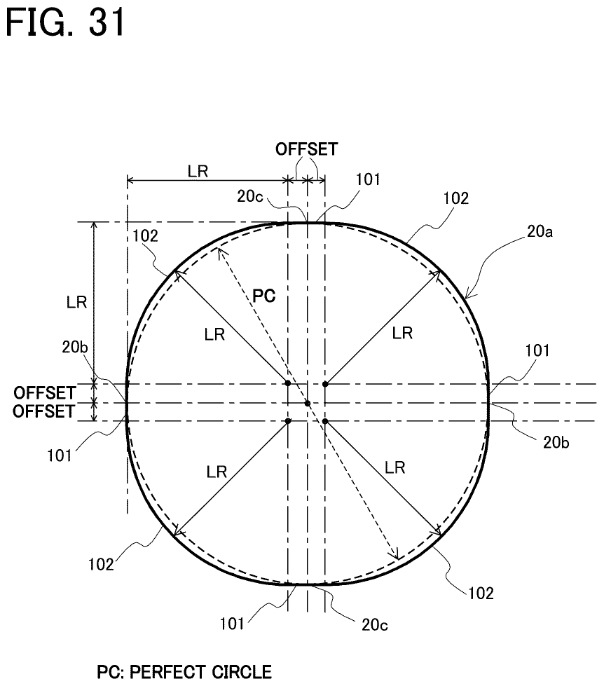

As a second variant example, as shown in FIG. 31, the opening edge 20a when seen from the rotary disk 40 side may also be shaped such that each first end portion 20b is formed with a straight portion 101 having a straight-linear shape intersecting the rotation direction of the rotary disk 40 (the lateral direction in FIG. 31). This straight portion 101 is one example of an “edge straight portion” of the disclosure.

In this variant example, as shown in FIG. 31, the opening edge 20a is further formed such that each second end portion 20c is formed with a straight portion 101 having a straight-linear shape intersecting the rotation direction of the rotary disk 40 (the lateral direction in FIG. 31), and a circular portion 102 with a radius LR is formed between the two straight portions 101.

As in the first variant example, accordingly, while the first seal member 81A is traversing the inflow path 20, the compression stress acting on the first seal member 81A is reduced just before the non-contact portion of the first seal member 81A with the housing 11 rides on the first end portion 20b of the opening edge 20a.

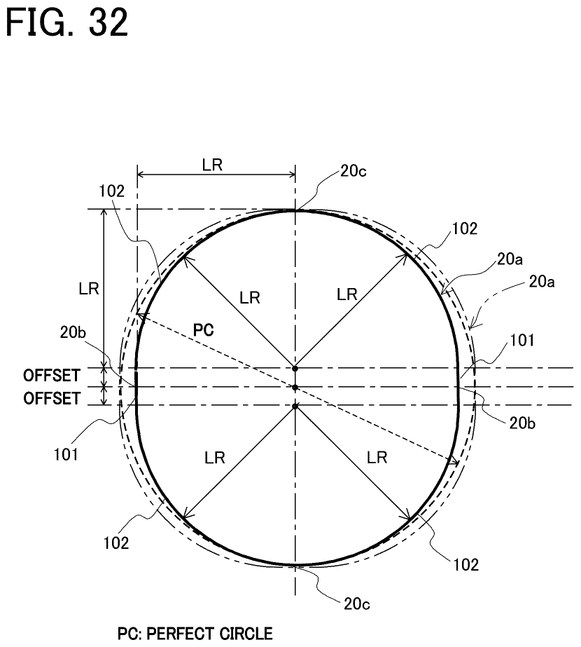

As shown in FIG. 32, the opening edge 20a when seen from the rotary disk 40 side may also be shaped such that each first end portion 20b is formed with the straight portion 101, but each second end portion 20c is not formed with the straight portion 101.

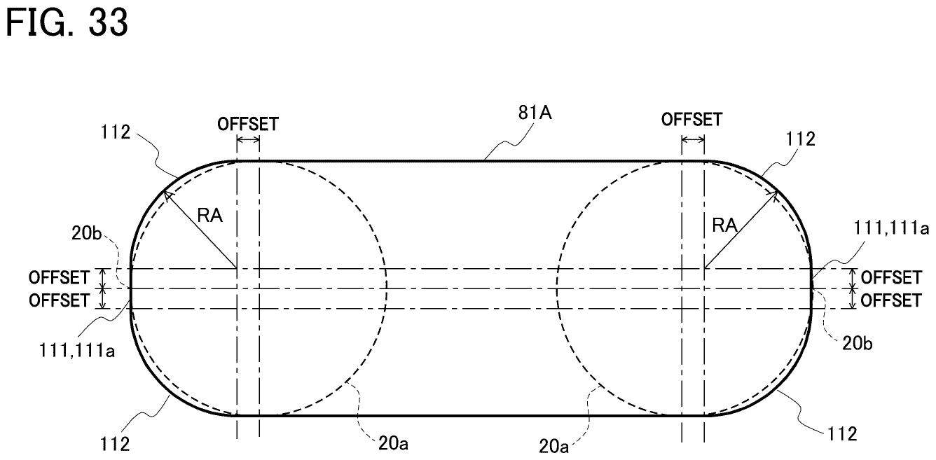

As a third variant example, as shown in FIG. 33, the first seal member 81A may be shaped to include a straight portion 111 at an end in the rotation direction of the rotary disk 40 (the lateral direction in FIG. 33). This straight portion 111 is formed in a straight-linear shape intersecting the rotation direction of the rotary disk 40. This straight portion 111 is one example of a “seal-member straight portion” of the disclosure. As an alternative, a nearly-straight portion 111a of a nearly straight-linear shape (or also referred to as a small curvature portion that is curved with a small curvature) may be formed instead of the straight portion 111. This nearly-straight portion 111a is one example of “seal-member nearly-straight portion” of the disclosure.

In this variant example, as shown in FIG. 33, the first seal member 81A is shaped such a shape that a portion that will pass across the first end portion 20b is formed with the straight portion 111 or the nearly-straight portion 111a, and a circular portion 112 is formed on both sides of the straight portion 111 or the nearly-straight portion 111a. The circular portion 112 extends circumferentially with a radius RA.

In this way, the first seal member 81A is shaped such that the end portion in the rotation direction of the rotary disk 40, that is, the portion that is once released into the inflow path 20 and rides on the first end portion 20b when the first seal member 81A passes across the inflow path 20 by rotating the rotary disk 40 relative to the housing 11 (i.e., the non-contact portion with the housing 11) is formed in a straight-linear shape intersecting the rotation direction of the rotary disk 40.

This configuration reduces the compression stress acting on the first seal member 81A just before the non-contact portion of the first seal member 81A with the housing 11 rides on the first end portion 20b of the opening edge 20a. Thus, the protruding amount of the first seal member 81A into the inflow path 20 is reduced. This allows the non-contact portion of the first seal member 81A with the housing 11 to smoothly ride on the first end portion 20b of the opening edge 20a.

The foregoing embodiments are mere examples and give no limitation to the disclosure. The disclosure may be embodied in other specific forms without departing from the essential characteristics thereof.

For example, when the second seal members 81B traverses the fixed-disk communication paths 70 of the fixed disk 50 during rotation of the rotary disk 40, the details of the second embodiment and each variant example are also applied to the fixed-disk communication paths 70 and the second seal members 81B.

### REFERENCE SIGNS LIST

1,2 Flow path switching device
11 Housing
12 Valve body unit
14 Control unit
20 Inflow path
20a Edge
20b First end portion
20c Second end portion
21 First inflow path
22 Second inflow path
23 Third inflow path
30 Outflow path
31 First outflow path
32 Second outflow path
33 Third outflow path
40 Rotary disk
41 Circular plate part
50 Fixed disk
51 Circular plate part
60 Rotary-disk communication path
61 First rotary-disk communication path
62 Second rotary-disk communication path
63 Third rotary-disk communication path
70 Fixed-disk communication path
71 First fixed-disk communication path
72 Second fixed-disk communication path
73 Third fixed-disk communication path
81A First seal member
81B Second seal member
101 Straight portion
111 Straight portion
111a Nearly-straight portion
211 Housing
212 Slide valve
220 Flow path port
260 Slide-valve communication path
281 Seal member
L Central axis
LA Inner periphery (of opening edge)
LB Outer periphery (of opening edge)
r1 Radius
r2 Radius
CU1 First opening curvature
CU2 Second opening curvature

1. A flow path switching device comprising:
at least one fixed member; and
a driving member,
the at least one fixed member including a port,
the driving member including a communication path, and
the port of the at least one fixed member is communicated with the communication path of the driving member to form a flow path through which fluid flows,
wherein the driving member is provided with a seal member that contacts with the at least one fixed member under action of a pressing force and seals a gap between the port of the at least one fixed member and the communication path of the driving member communicated with the at least one fixed member, and
the driving member has a higher rigidity than the at least one fixed member.

2. The flow path switching device according to claim 1, wherein
the at least one fixed member includes a first fixed member and a second fixed member,
the driving member is placed between the first fixed member and the second fixed member,
the seal member includes a first seal member provided between the first fixed member and the driving member and a second seal member provided between the driving member and the second fixed member,
the driving member is held between the first fixed member and the second fixed member under action of the pressing force through the second fixed member and the second seal member, and
the port of the second fixed member is placed in a position where the port does not traverse the second seal member when the driving member is driven to switch patterns of the flow path.

3. The flow path switching device according to claim 1, wherein
the port of the at least one fixed member includes an opening edge on a side facing the driving member, the opening edge being formed with R or a taper, and
a size of the R or taper is larger at a first end portion, which is an end portion of the opening edge in a driving direction of the driving member, than at a second end portion, which is an end portion of the opening edge in a direction perpendicular to the driving direction of the driving member, and the size of the R or taper gradually decreases from the first end portion toward the second end portion.

4. The flow path switching device according to claim 1, wherein
when the driving member is driven to switch patterns of the flow path, a driving speed of the driving member is set to a first low speed that is slower than a normal speed while the seal member is traversing the port of the at least one fixed member.

5. The flow path switching device according to claim 4, wherein
when the driving member is driven to switch the patterns of the flow path, the driving speed of the driving member is set to a second low speed that is slower than the first low speed while the seal member is shifting from a state of traversing the port of the at least one fixed member to a state of not traversing the port.

6. The flow path switching device according to claim 1, wherein
the port of the at least one fixed member includes an opening edge on a side facing the driving member, the opening edge being formed with R or a taper,
a size of the R or taper is larger at a first end portion which is an end portion of the opening edge in a driving direction of the driving member than at a second end portion which is an end portion of the opening edge in a direction perpendicular to the driving direction of the driving member, and
a radius of an inner periphery of the opening edge and a radius of an outer periphery of the opening edge at the first end portion are equal or approximately equal to those at the second end portion.

7. The flow path switching device according to claim 6, wherein
when it is assumed that the radius of the inner periphery of the opening edge is r1 and the radius of the outer periphery of the opening edge is r2, the size of the R at the first end portion is larger than (r2−r1).

8. The flow path switching device according to claim 1, wherein
the port of the at least one fixed member includes an opening edge on a side facing the driving member, the opening edge being shaped such that a first opening curvature that is a curvature of a first end portion, which is an end portion of the opening edge in a driving direction of the driving member, is smaller than a second opening curvature that is a curvature of a second end portion, which is an end portion of the opening edge in a direction perpendicular to the driving direction of the driving member.

9. The flow path switching device according to claim 1, wherein
the port of the at least one fixed member has an opening edge on a side facing the driving member, the opening edge is shaped such that a first end portion, which is an end portion of the opening edge in a driving direction of the driving member, is formed with an edge straight portion having a straight-linear shape intersecting the driving direction.

10. The flow path switching device according to claim 1, wherein the seal member is shaped such that an end portion in a driving direction of the driving member is formed with a seal-member straight portion having a straight-linear shape or a seal-member nearly-straight portion having a nearly straight-linear shape intersecting the driving direction.

11. The flow path switching device according to claim 2, wherein
the port of the at least one fixed member includes an opening edge on a side facing the driving member, the opening edge being formed with R or a taper, and
a size of the R or taper is larger at a first end portion, which is an end portion of the opening edge in a driving direction of the driving member, than at a second end portion, which is an end portion of the opening edge in a direction perpendicular to the driving direction of the driving member, and the size of the R or taper gradually decreases from the first end portion toward the second end portion.

12. The flow path switching device according to claim 2, wherein
when the driving member is driven to switch patterns of the flow path, a driving speed of the driving member is set to a first low speed that is slower than a normal speed while the seal member is traversing the port of the at least one fixed member.

13. The flow path switching device according to claim 12, wherein
when the driving member is driven to switch the patterns of the flow path, the driving speed of the driving member is set to a second low speed that is slower than the first low speed while the seal member is shifting from a state of traversing the port of the at least one fixed member to a state of not traversing the port.

14. The flow path switching device according to claim 2, wherein
the port of the at least one fixed member includes an opening edge on a side facing the driving member, the opening edge being formed with R or a taper,
a size of the R or taper is larger at a first end portion which is an end portion of the opening edge in a driving direction of the driving member than at a second end portion which is an end portion of the opening edge in a direction perpendicular to the driving direction of the driving member, and
a radius of an inner periphery of the opening edge and a radius of an outer periphery of the opening edge at the first end portion are equal or approximately equal to those at the second end portion.

15. The flow path switching device according to claim 14, wherein when it is assumed that the radius of the inner periphery of the opening edge is r1 and the radius of the outer periphery of the opening edge is r2, the size of the R at the first end portion is larger than (r2-r1).

16. The flow path switching device according to claim 2, wherein
the port of the at least one fixed member includes an opening edge on a side facing the driving member, the opening edge being shaped such that a first opening curvature that is a curvature of a first end portion, which is an end portion of the opening edge in a driving direction of the driving member, is smaller than a second opening curvature that is a curvature of a second end portion, which is an end portion of the opening edge in a direction perpendicular to the driving direction of the driving member.

17. The flow path switching device according to claim 2, wherein
the port of the at least one fixed member has an opening edge on a side facing the driving member, the opening edge is shaped such that a first end portion, which is an end portion of the opening edge in a driving direction of the driving member, is formed with an edge straight portion having a straight-linear shape intersecting the driving direction.

18. The flow path switching device according to claim 2, wherein the seal member is shaped such that an end portion in a driving direction of the driving member is formed with a seal-member straight portion having a straight-linear shape or a seal-member nearly-straight portion having a nearly straight-linear shape intersecting the driving direction.
